(19) United States
(12) Patent Application Publication
(10) Pub. No.: US 2019/0334206 A1
(43) Pub. Date: Oct. 31, 2019

(54) MULTIPLE ACTIVE AND INTER LAYERS IN A SOLID-STATE DEVICE

(71) Applicant: Dyson Technology Limited, Wiltshire (GB)

(72) Inventors: Ann Marie SASTRY, Ann Arbor, MI (US); Chia-Wei WANG, Ypsilanti, MI (US); Yen-Hung CHEN, Ann Arbor, MI (US); HyonCheol KIM, Ann Arbor, MI (US); Xiangchun ZHANG, Ann Arbor, MI (US); Myoungdo CHUNG, Ann Arbor, MI (US)

(73) Assignee: Dyson Technology Limited, Wiltshire (GB)

(21) Appl. No.: 16/510,376

(22) Filed: Jul. 12, 2019

Related U.S. Application Data
(63) Continuation of application No. 15/705,449, filed on Sep. 15, 2017.

(51) Int. Cl. H01M 10/0565; H01M 10/04; H01M 10/0562; H01M 10/05; C08J 5/22; H01M 10/0585; H01M 10/0525

(52) U.S. Cl. CPC H01M 10/0565; H01M 10/0436; H01M 10/0562; H01M 6/40; C08J 5/22; H01M 10/0585; H01M 10/0525; H01M 10/05

(57) ABSTRACT

A multi-layered solid-state battery device can have a substrate member having a surface region and a thin film battery device layer overlying the barrier material. The thin film battery device layer can comprise a cathode current collector, a cathode device, an electrolyte, an anode device, and an anode current collector. The device can have a non-planar surface region configured from the thin film battery device and a first polymer material overlying the thin film battery device and configured to fill in a gap region of the non-planar surface region and a planarizing surface region configured from the first polymer material.

### REFERENCE TO RELATED APPLICATIONS

This application is a continuation of U.S. patent application Ser. No. 15/705,449, filed Sep. 15, 2017, the entire contents of which are incorporated herein by reference.

### FIELD OF THE INVENTION

The present invention relates generally to fabricating a thin film electrochemical energy storage device or a solid-state battery device. More particularly, the present invention provides techniques using multiple active layers and interlayers for the manufacture of a solid-state battery device.

### BACKGROUND OF THE INVENTION

Common electro-chemical cells often use liquid electrolytes. Such cells are typically used in many conventional applications. Alternative techniques for manufacturing electro-chemical cells include solid-state cells. Such solid-state cells are generally in the experimental state, have been difficult to make, and have not been successfully produced in large scale. Although promising, solid-state cells have not been achieved due to limitations in cell structures and manufacturing techniques.

### SUMMARY OF THE INVENTION

The present invention provides a method for fabricating a thin film electrochemical energy storage device or an all solid-state device to achieve better performance and longer cycle lifetime by using multiple active and inter thin film layers serving either as stress mitigation means, thermal control means, ionic diffusion prevention means, ionic diffusion enhancing means, enhancing electrical conduction means, electrical insulation means, adhesion means, or planarizing means for subsequent layers. The performance of those devices can either be electrical-chemical conversion efficiency, energy density, power density, photovoltaic conversion efficiency, electrical conduction, electrical insulation, or high/low temperature operational capabilities.

The thin film energy storage device, and all solid-state devices that the method of present invention can apply to, can be used for a variety of applications such as a solar panel, a consumer electronic device, a vehicle, or an electrical grid; wherein the consumer electronic devices include, but not limited to: display device, MP3 players, smartphones, tablets, laptop computers, smartwatches, activity trackers, and other wearable devices; wherein the vehicles include, but not limited to: hybrid electric buses, electric buses, hybrid electric cars, electric cars, electric bicycles, electric motorcycles, electric scooters, electric golf carts, trains, ships, airplanes, electric airplanes, helicopters, unmanned aerial vehicles, electric unmanned aerial vehicles, drones, other aerial vehicles, space stations, space shuttles, space planes, satellites, unmanned spacecrafts, other spacecrafts, and other hybrid electric vehicles, plug-in hybrid electric vehicles, and electric vehicles; and wherein the electrical grid includes, but not limited to stand-alone micro-grids for residential homes, commercial buildings, and communities, and centralized electrical grids. Furthermore, such energy storage devices can be used for telecommunication systems, cellphone and antenna towers, data centers, and uninterruptable power supplies.

In some embodiments, the present invention provides a method of using planarizing layers in a thin film electrochemical energy storage system or an all solid-state devices to overlay flaws and prevent failures. The flaws refer to the roughness, pinholes, and cracks occurring at the surface of a previous layer. These flaws can induce high contact resistance because of a poor connection between two consecutively connected layers and can cause delamination due to poor adhesion. They can also cause fatigue or mechanical failure due to stress concentrations during cyclic loading. These planarizing layers are deposited by using a thin-film related deposition process to flatten the flaw on the surface of previously laying down layer. The functions of these planarizing layers include, but are not limited to, mitigating flaws, preventing mechanical failures, prevent an oxygen species, a water species, a nitrogen species, and a carbon dioxide species from diffusing into the first electrochemical/electrical active layer(s), and to prevent any material comprising the second layer from bonding to, alloying, mixing or forming a composite with the first layer. Furthermore, because the flaws are flattened, the subsequent deposited layers have a better foundation and better adhesion to achieve better uniformity of the thin film component layers.

In some embodiments, these intermediary thin-film planarizing layers are configured overlying the flaws of an electrochemical/electrical active layer(s) within a thin film energy storage device or other solid-state device having inert physical properties. The materials used to form these layers can be categorized into four groups, but not limited to, based on their functions:
a. as an electrical/thermal insulator or chemical inertness with low electrical/thermal conductivity;
b. as a high thermal conductor with high thermal conductivity;
c. as a moisture resistance layer with low ionic species diffusivity or reactivity; or
d. as a planarizing layer with high wettability and good adhesion force with previous layers to mitigate the stress concentration and decrease contact resistance.

The choice of deposition method of forming the planarizing layers can depend on the types of material needed to be formed, the type of material properties intended to generate, and the type of microstructure of material intended to form. These methods include, but are not limited to, aerosol deposition, thermal evaporation, phase-change liquid feeder assisted thermal evaporation, e-beam vapor deposition, radio frequency magnetron sputtering, direct current magnetron sputtering, physical vapor deposition (PVD), chemical vapor deposition, low pressure chemical vapor deposition (LPCVD), atomic layer deposition (ALD), direct laser writing (DLW), sputtering, microwave plasma enhanced chemical vapor deposition (MPECVD), pulsed laser deposition (PLD), nano imprint, ion implantation, laser ablation, spray deposition, spray pyrolysis, spray coating and plasma spraying. After the deposition of the stacked cells or single layer of cells, the solid-state battery device or subunit can be rapidly heated to a target temperature for at least 10 seconds to burn out or oxidize certain layers to serve as detaching or smoothing layers between stacked cells or layers.

In some embodiments, inert layers overlay other layers of dissimilar materials to constrain the diffusion of species and conduction of electrons, wherein the stacking sequence of said layers is either a single stack or a stack repeating one or more times. The inert layer can be used to prevent diffusion of strong reactive species throughout the layers within the thin film energy storage device or an all solid-state devices. The strong reactive species that the inert layers try to control, include, but are not limited to, lithium atoms, lithium ions, protons, sodium ions, and potassium ions, or other ionic species. The inert layers are selected from materials including, but not limited to, polymeric materials, aluminum oxide, and other ceramics, which have diffusion coefficients lower than 1×10⁻¹⁷ m²/s of strong reactive species so that the strong reactive species hardly diffuse through the barrier layer. Another function of the inert layer is to prevent conduction of electrons; wherein the inert layer is selected from materials including, but not limited to, polymeric materials, aluminum oxide, and/or other ceramics having electrical conductivities lower than 1×10⁻⁷ m²/s.

In some embodiments, one or more thin film planarizing layers overlying the electrical/electrochemical active layer of a thin film energy storage device or an all solid-state device are configured to enable device operations under high temperature, ruggedness, resistance to harsh environments including chemical and physical degradation, and provides electrical isolation. To achieve this aim, several thin-film layers are deposited on top each other to form functional unit: a thin film adhesive layer in continuous physical contact with a non-planar electrical/electrochemical active layer of a solid-state electrochemical energy storage device or electronic device; another one or more thermally conductive or thermally insulated layers depending on the intended function, deposited overlying said adhesive layer and the thermally conductive layers being wired to a heat sink location to transport the heat generated inside the device to outside; finally a protective layer deposited upon said thermally conductive layer or said thermally insulated layer depending on whether this unit is exposed to the environment or still embedded inside the device. These layers can form a functional unit that can be used to control temperature inside a thin film energy storage device or an all solid-state device. This unit can be sandwiched between two functionally active layers. Otherwise, the protective layer of this functional unit will face the external environment.

In some embodiments, a two layer electrolyte having different physical properties can be used to provide proper function as electrolyte in and to reduce fabrication time of a thin film electrochemical energy storage system. The physical properties include, but are not limited to, mass density, crystal structure, ionic conductivity, ionic diffusivity, electronic conductivity, dielectric constant, sheet resistance, contact resistance, mechanical strength, mechanical hardness, thermal expansion coefficient, and concentration expansion coefficient. The first layer of the two-layered electrolyte is thinner, tolerant of high temperature, and stiff to prevent dendrite growth and shortening. The second layer of this two-layered electrolyte is thicker and with lower ionic diffusivity for strong reactive species. One or more of the physical properties is tailored to mitigate issues related to diffusion, electrical conduction, mechanical stress, inert or less diffusive external species or strong reactive species so that the cycle life of the overall system can be improved.

In some embodiments, the method uses diffusing layers in a thin film electrochemical system or other thin film devices, such as displays, solar cells, electrochromic glasses, etc., to mitigate process-intrinsic and/or environmental stress by using multilayer materials. One of the diffusing layers is a disappearing layer, which uses a highly diffusive material so that this layer will be evacuated as the species are diffused through neighboring layers. The vacated space or void spatial region will be served as a stress discontinuity so that overall stresses inside the thin film electrochemical system or thin film devices will be reduced and the system's service life will be prolonged. The second layer of the diffusing layers serves as a passage layer, which utilizes materials having high ionic conductivity for highly diffusive species in the disappearing layer. The third layer of the diffusing layers serves as an overlaying layer and as a diffusion host, which will react with highly diffusive species in the disappearing layer to form an alloy, and to accommodate the diffusive species for future usage. This overlaying layer will become a diffusion host for highly diffusive species after the disappearance layer is vacated and stored in this overlaying layer. The needs of highly diffusive species will be provided from this diffusion host layer. As used herein, the term “diffusion host” also means the “trapping region or layer.” In an example, the present invention provides a multi-layered solid-state battery device. The device has a substrate member, which has a surface region. The device has a barrier material comprising a polymer material overlying the surface region. The device has a thin film battery device layer overlying the barrier material. In an example, the thin film battery device layer comprises a cathode current collector, a cathode device, an electrolyte, an anode device, and an anode current collector. The device has a non-planar surface region configured from the thin film battery device. The device has a first polymer material overlying the thin film battery device and configured to fill in a gap region of the non-planar surface region and a planarizing surface region configured from the first polymer material. The device has a transferring material overlying the first polymer material and a trapping material overlying the lithium material. The device has a void region configured between the first polymer material and a portion of the trapping material by diffusing a plurality of transferring species from the transferring material to traverse from a spatial region defined by the transferring material after forming the transferring material to the trapping material and a second polymer material overlying the trapping material. As used herein and throughout the specification, the terms “first” “second” or “Nth” do not imply any order, and should be interpreted broadly. The device has a plurality of N thin film battery devices overlying the second polymer material. Each of the plurality of N thin film battery devices has an associated void region to substantially remove a strain component between each of the plurality of N thin film battery devices with an associated one of the plurality of N thin film battery devices.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1A is a simplified cross-sectional view of thin film electrochemical energy storage cell according to an embodiment of present invention.

FIG. 1B is a simplified cross-sectional view of a modified thin film electrochemical cell with an additional diffusion barrier layer over the bridge region between the electrolyte and the anode layers according to an embodiment of present invention.

FIG. 2A is a simplified cross-sectional view of a thin film electrochemical energy storage cell according to an embodiment of the present invention.

FIG. 2B is a photograph of a thin film electrochemical energy storage cell according to an embodiment of the present invention.

FIG. 2C is a microscopic graph view of the same area as the schematic drawing shown in FIG. 2A according to an embodiment of present invention.

FIGS. 2D and 2E are microscopic graph views of the same area as the schematic drawing of FIG. 2A in which a light is shone from the bottom of the specimen according to embodiments of the present invention.

FIG. 2F is a scanning electron microscope graph of the “bridge” region shown in FIG. 2C according to an embodiment of present invention.

FIG. 3A is a simplified cross-sectional view of the thin film electrochemical energy storage cell having three regions with an additional diffusion barrier layer deposited over a bridge region according to an embodiment of present invention.

FIG. 3B is a graph of showing a pristine anode surface across all three regions as shown in FIG. 3A according to an embodiment of the present invention.

FIGS. 4A-4F illustrate simplified cross-sectional views of each process step showing an electrochemical cell layer formed according to an embodiment of the present invention.

FIG. 5A is a scanning electron microscope graph of three stacks of thin film electrochemical energy storage cells without the interlayers and their cell voltages according to an embodiment of the present invention.

FIG. 5B is a scanning electron microscope graph of three stacks of thin film electrochemical energy storage cells with the interlayers and their cell voltages according to an embodiment of the present invention.

FIG. 6 is a graph representing discharge curves of consecutive 6 cycles of FIG. 5B stacks cells according to an embodiment of the present invention.

FIG. 7 is a schematic drawing, specs and material properties of two thin film layers sandwiched an intermediate layer according to an embodiment of the present invention.

FIG. 8 lists four different kinds of moduli of intermediate layer used in the simulation to demonstrate their effect on overall stress distribution inside stacked thin film energy storage cells according to an embodiment of the present invention.

FIG. 9 is stress distribution inside the stacked thin film electrochemical cells obtained by computer simulation according to an embodiment of the present invention.

FIG. 10 illustrates an interface region between a pair of thin film electrochemical cells according to an embodiment of the present invention.

FIG. 11 illustrates an interface region, including a void region, between a pair of thin film electrochemical cells according to an embodiment of the present invention.

FIG. 12 illustrates a non-uniform cathode material for a thin film electrochemical cell according to an embodiment of the present invention.

FIG. 13 illustrates a non-uniform cathode material configured with a polymer material or planarizing fill material for a thin film electrochemical cell according to an embodiment of the present invention.

FIG. 14 is a simplified flow diagram illustrating a method for fabricating a thin film solid-state energy storage device according to an embodiment of the present invention.

FIG. 15 is a simplified diagram illustrating a thin film solid-state energy storage device according to an embodiment of the present invention.

### DETAILED DESCRIPTION OF THE INVENTION

Formed layers or films can be detrimental to neighboring layers due to specific material properties that will reduce their operational lifetime. To overcome these limitations, the present invention provides a different design and fabrication philosophy: taking into account the whole system and its intended operational conditions then inserting multiple active or non-active layers where they are needed without sacrificing the functionalities of other active layers, but inhibiting factors that lead to low operational lifetime through these intermediate layers.

Conventional solid-state thin film batteries are typically characterized by the following characteristics:
A. low overall energy/capacity;
B. limited applications;
C. single layers;
D. low volumetric energy density;
E. low gravimetric energy density;
F. long cycle life; and
G. safe.

For items D, E, and F, the overall specific energy, energy density and long cycle life can be much higher than lamination batteries by proper design and fabrication. Conventional thin film battery technology does not fully utilize its superiority of safety and long cycle life over the lamination technologies by choosing thick substrate and packaging layers, which sacrifices its specific energy, and energy density. At the same time, the sophisticated intrinsic physical mechanisms involved in thin-film electrochemical energy storage system require compromising and tailoring each electrode material properties to integrate them together to form a functional system. For example, the current art of thin film batteries considers having high crystalline structure in cathode electrode desirable to achieve high energy density.

However, to achieve high crystalline structure requires high annealing and high deposition temperature, which makes high crystalline structure film extremely brittle. Therefore, using such cathode structures often requires a stiff and thick substrate to maintain electrode structure stability, which limits the practical usage of the thin film battery. Because of the compromise, it further reduces the specific energy and energy density. Furthermore, the constraints of a high temperature production method involving the stacking up of cells only achieves useable energy and capacity for smartphone, wearable electronic device, and electrical vehicle applications without achieving high energy density and high specific energy.

On the other hand, lamination batteries can provide a moderate overall capacity by wrapping larger area of cell to pack inside a limited volume, but its low safety factor, low cycle life, low overall volumetric energy density and low gravimetric energy density cause the potential of lamination batteries to reach a plateau in capable performance, such as energy density, cycle life and safety. In order to break through lamination batteries' low specific energy and energy density, cycle life, and to combine thin film batteries' superiorities with those characteristics, the design of the thin film electrochemical energy storage device and its production method need to be changed.

Solid-state electronic devices represent another field that benefits from the application of the present invention to its current design and fabrication techniques. Electronic devices, such as field effect transistors (FETs), are used in display devices and logic capable circuits. A conventional FET typically includes source, drain and gate electrodes, a semiconducting layer made of a semiconductor (SC) material, and an insulator layer (also referred to as “dielectric” or “gate dielectric”), made of a dielectric material and positioned between the SC layer and the gate electrode. The semiconductor is for example an organic semiconductor (OSC), and the electronic device is for example an organic electronic (OE) device. The current needs for this field are improving the adhesion force and increase the surface energy of dielectric layer.

Furthermore, thin film photovoltaic modules (also known as “solar panels”), which also utilize semiconductor material with thin-film production methods, can also be benefit by utilizing the method proposed in this invention. This type of device utilizes the junction of an n-type layer and a p-type layer to convert radiation energy (sunlight) in lower or diffuse light conditions to lower band gap materials in order to generate electric potential and electric current. However, this intermixing of the n-type layer and the p-type layer at the junction region can lead to undesirable diffusion of ions and/or dopants between these two layers, which can decrease the efficiency and lifetime of this type of device. Hence, there is a need to improve energy conversion efficiency and photovoltaic device lifetime through reduced dopant and ionic diffusion between n-type layer and p-type layer and aiding in reducing recombination of generated carriers at the interface of the n-type layer and p-type layer.

The aims of the present invention include utilizing intermediately active or non-active layers to isolate issues related to neighboring layers due to production methods, operational conditions, and intrinsic material properties, so that the thin film electrochemical energy storage device or all solid-state device to achieve high performance and long operational lifetime.

In an alternative embodiment, a solid-state battery or other solid-state thin film device having inert properties can be configured with thin film planarizing layers to mitigate flaws, to prevent mechanical failures due to an oxygen species, a water species, a nitrogen species, and a carbon dioxide species from diffusing into electrochemical/electrical active layers, or to prevent contamination from bonding to, alloying, mixing or forming a composite with the first layer due to the formation of this intermediated one more thin film layers. The materials used to form these intermediary one or more thin film planarizing layers can be configured overlying the first electrochemical/electrical active layer(s) within the solid-state device.

The selection of the materials to form this planarizing layer unit is closely dependent on its intended function. If this planarizing layer is also used as an electrical/thermal insulator, or chemical inertness, the materials for this planarizing layer can be selected from a group of ceramics, which includes, but is not limited to, soda-lime glass, borosilicate glasses, NASICON, similar to LiAlCl4 structure, β or β″-alumina structure, or perovskite-type structure, aLiₓPO₄-bLi₂S-cSiS₂ where a+b+c equals to 1, LiSON, LiₓLa₁₋ₓZrO₃, LiₓLa₁₋ₓTiO₃, LiAlGePO₄, LiAlTiPO₄, LiSiCON, Li_{1.3}Al_{0.3}Ti_{1.7}(PO₄)₃, 0.5LiTaO_{3+0.5}SrTiO₃, Li_{0.34}La_{0.51}TiO_{2.94}, LiAlCl₄, Li₇SiPO₈, Li₉AlSiO₈, Li₃PO₄, Li₃SP₄, LiPON, Li₇La₃Zr₂O₁₂, Li_{1.5}Al_{0.5}Ge_{1.5}(PO₄)₃, Li₆PS₅Cl, Li₅Na₃Nb₂O₁₂; or a set of polymer: PEO, oligomeric ethylene oxide groups and silicon-based groups distributed in alternating positions between the oligomeric ethylene oxide groups. If this planarizing layer is also used as a high thermal conductor, the material for this layer can be selected from a group ceramics, including but not limited to, aluminum oxide, aluminum nitride, zirconium dioxide (zirconia), magnesium oxide, yttrium oxide, calcium oxide, cerium (III) oxide and boron nitride. If this planarizing layer is used also for moisture resistance, the material for this planarizing layer can be selected from a group including, but not limited to, metals, glass, ceramics, mica, silicone resins, asbestos, acrylics, diallyl phthalate, and plastic resins. After the deposition of the stacked cells or single layer of cell, the solid-state battery device or subunit can be rapidly heating to a target temperature for at least 60 minutes for burning out or oxidizing certain layer to serve as detaching or smoothing layer between stacked cells or layers.

In an alternative embodiment, one or more planarizing layers are used to fills pinholes and cracks. The thicknesses, orders and selection of these planarizing layers depend on the flaw dimensions, and type of the materials of the proceeding layers. Furthermore, the types of microstructures of these planarizing layers can alter their own material properties. Carefully choosing the proper evaporation methods are necessary because types of evaporation methods, their background gases, and substrates, evaporation source temperatures are closely related to the end product's microstructure of the films. The contact resistance and the residual stress induced during deposition process can be reduced, and the flat surface of planarizing layer provides a foundation for subsequent layers' uniformity in plane dimension within the device, once the crack, pinholes and roughness of preceding layers are flatten by planarizing layers.

In some embodiments, the present invention provides a method utilizing one or more inert layers overlying other layers of dissimilar materials to constrain diffusion of species or conduction of electrons, wherein the stacking sequence of said layers is either in a single stack or in repeats one or more times. The inert layer used to prevent diffusion of strong reactive species throughout the layers within the thin film energy storage device or an all solid-state devices. The strong reactive species that the inert layers try to control, include, but are not limited to, lithium atoms, lithium ions, protons, sodium ions, and potassium ions, or other ionic species. The inert layers are selected from materials including, but not limited to, polymeric materials, aluminum oxide, and other ceramics, which have ionic diffusion coefficients lower than 1×10⁻¹⁷ m²/s for the strong reactive species so that the strong reactive species are hardly diffusing through. Another function of inert layer is to prevent conduction of electrons; where the inert layer is selected from materials including, but not limited to, polymeric materials, that the electrons are hardly conducting through these layers. Alternating these inter layers of these two groups of material layers can control both ionic species and electrons.

In some embodiments, one or more thin film planarizing layers are configured or deposited overlying the electrical/electrochemical active layer of a thin film energy storage device or an all solid-state device to enable device operation under high temperature and ruggedness, to provide resistance to harsh environments, including chemical and physical degradation, and to provide electrical isolation. To achieve these goals, several thin-film layers deposited on top each other to form a functional unit: a single thin film adhesive layer in continuous physical contact with an non-planar electrical/electrochemical active layer of a solid-state electrochemical energy storage device or electronic device; another one or more thermally conductive layers deposited overlaying on proceeding adhesive layer and wired to a heat sink location to transport the heat generated inside the device to outside environment so that a tolerable temperature inside this device is maintained; extra one or more relatively thermally insulated layers deposited overlaying on thermally conductive layers if this device was mounted or installed around high temperature emitter so that the heat from the emitter can be controlled and not be conducted into the device; finally an protective layer deposited upon proceeding thermally conductive layer or thermally insulated layer depending on whether this unit is exposed to the environment or still embedded inside another well temperature controlled device. When this functional unit used to control temperature is inside the thin film energy storage device or an all solid-state device, this unit can be sandwiched between two functionally active layers. Otherwise, the protective layer of this functional unit will be facing to external environment.

In another alternative embodiment, the present invention provides a method of utilizing one or more thin film planarizing layers overlying the electrical/electrochemical active layer of a thin film energy storage device or an all solid-state device to enable device operation under high temperature and ruggedness, to provide resistance to harsh environments, including chemical and physical degradation, and to provide electrical isolation. To achieve these goals, several thin-film layers sequentially are deposited on top each other to form a functional unit, where the first layer is a single thin film adhesive and other layers, in no specific order are as follows:
a. one or more thermally conductive layers,
b. extra one or more relatively thermally insulated layers,
c. a high dielectric strength material,
   and completing with a protective layer if necessary.

In some embodiments, the adhesive layer has total thickness less than 100 Angstroms, and the materials of this adhesive layer are selected from either: a group of elastomers, such as butyl, styrene butadiene, phenolic, polysulfide, silicone, or neoprene; a group of polymer electrolytes, such as metal salts, AX (where A⁺ is anodic ion and is selected from a group of metals, but not limited to, Li⁺, Na⁺, Mg²⁺, etc., and X⁻ is cathodic ions, but are not limited to, I⁻, Cl⁻, Br⁻, ClO₄⁻, CF₃SO₃⁻, BF₄⁻, and AsF₆⁻), in polymer where polymer is chosen from a group of polymer such as, poly(ethylene oxide) (PEO), poly(propylene oxide) (PPO), poly(ethylene glycol) (PEG), poly(vinylidene fluoride) (PVdF) , poly(acrylonitrile) (PAN), poly(methyl methaacrylate) (PMMA), poly(vinylidene fluoride-hexafluoroproplene) (PVdF-co-HFP); a group of plastic polymers, such as cyanoacrylate, polyester, epoxy, phenolic, polymide, polyvinylacetate, polyvinyl acetal, polyamide, acrylic; a group of ceramic or glass if the temperature range of elastomer and plastic polymers not suitable, such as zirconium oxide, ruthenium oxide, rhodium oxide, iridium oxide, osmium oxide, zirconium boride, titanium nitride, tungsten carbide, tantalum nitride, tungsten nitride, titanium boride, tantalum boride, tungsten boride, lead-alkali borosilicate, or from a group of metal from zirconium, titanium, rhodium, iridium, osmium, or palladium. The one or more thermally conductive layers are deposited overlaying on the proceeding adhesive layer, and these layers have total thickness less than 1 micron. The types of materials for conducting heat out this device can be selected either from a group of ceramic, such as aluminum oxide, aluminum nitride, boron nitride, zinc oxide, indium tin oxide and mica; or a group of metal, such as aluminum, silver copper, zinc, indium, tin.

In some embodiments, the next step can include one or more relative thermally insulated intermediate layers being deposited overlying the thermally conductive layer as high temperature emitter devices in current device's neighborhood or within a vicinity of the device so that the high temperature will not be emitted into current device. These relative thermally insulated intermediate layers have thicknesses of less than 1 micron when needed. The types of materials that can be used to insulating temperature can be selected either from a group of ceramic, such as soda-lime, mica, and borosilicate; from a group of metal, such as aluminum, silver copper, zinc, indium, and tin; or from a group of polymers, such as ethylene (E), polyethylene, propylene (P), vinyl fluoride, vinylidene fluoride, tetrafluoroethylene, hexafluoropropylene, perfluoropropylvinylether, perfluoromethylvinylether, chlorotrifluoroethylene, polycarbonate, polyetherimide (PEI), polymide, polystyrene, epoxy, and phenolic materials.

In some embodiments, two different physical properties layered electrolyte in a thin film electrochemical energy storage system is used to provide proper function as electrolyte and to reduce fabrication time. The candidates for these controlled physical properties include, but are not limited to, mass density, crystal structure, ionic conductivity, ionic diffusivity, electronic conductivity, dielectric constant, sheet resistance, contact resistance, mechanical strength, mechanical hardness, thermal expansion coefficient, and concentration expansion coefficient. The first layer of this two-layered electrolyte is thinner, tolerable for high temperature, and stiff to prevent dendrite growing and electrically shortening. The second layer of this two-layered electrolyte is thicker and with lower ionic diffusivity for strong reactive species, and one or more of the physical properties would be tailored to have certain properties so that it could use to mitigate issues related to either the diffusion, electrical conduction, mechanical stress, inert or less diffusive for external species or strong reactive species so that the cycle life of the overall system can be improved.

In some embodiments, present invention provides a method of using plurality of bi-layers in a thin film electrochemical system or other solid-state devices to prevent diffusion of Li or other active species from the solid-state device and to protect thin film electrochemical system or solid-state device from service environments that can react with the active materials such as oxygen, moisture or nitrogen. In this bi-layered functional unit, the first layer is a polymer layer, which is inert and will not react with the active material. This polymer layer has two functions: preventing diffusion of the active material ionic species, and serving as planarizing layer for subsequent layer. The second layer of this bi-layered functional unit is comprised of inorganic materials. The second layer serves as a barrier to the species that can diffuse from the environment, such as oxygen, nitrogen, and moisture. Combination of this bi-layered functional unit can prevent the active species of this device reacting with external species and prevent the useful capacity or energy loss due to reaction of active species and external species.

### EXAMPLE 1

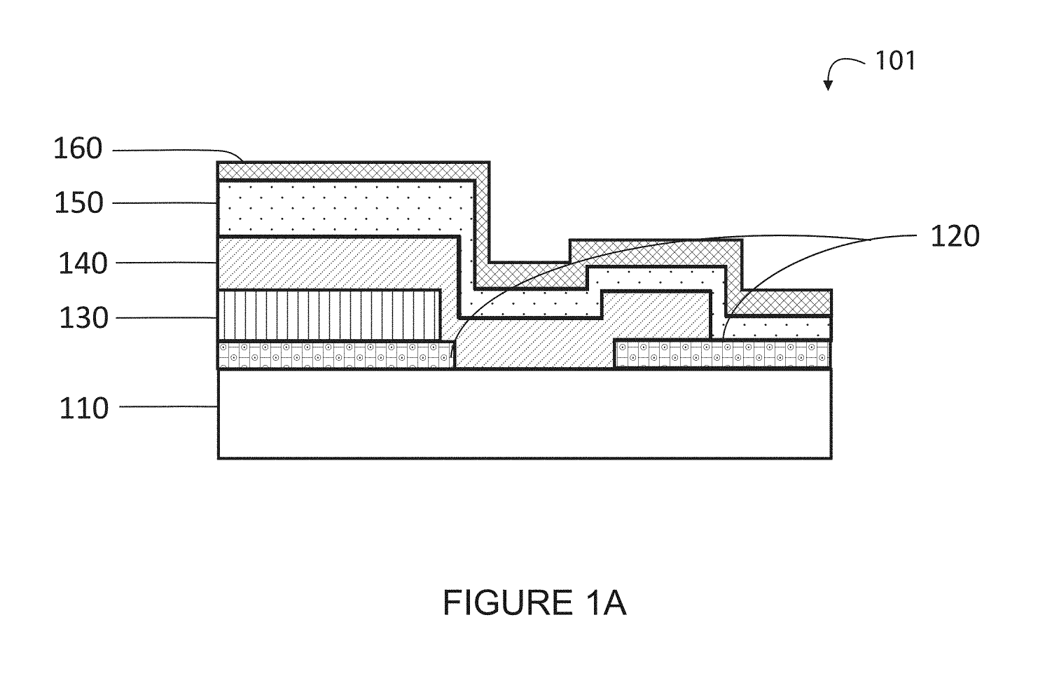

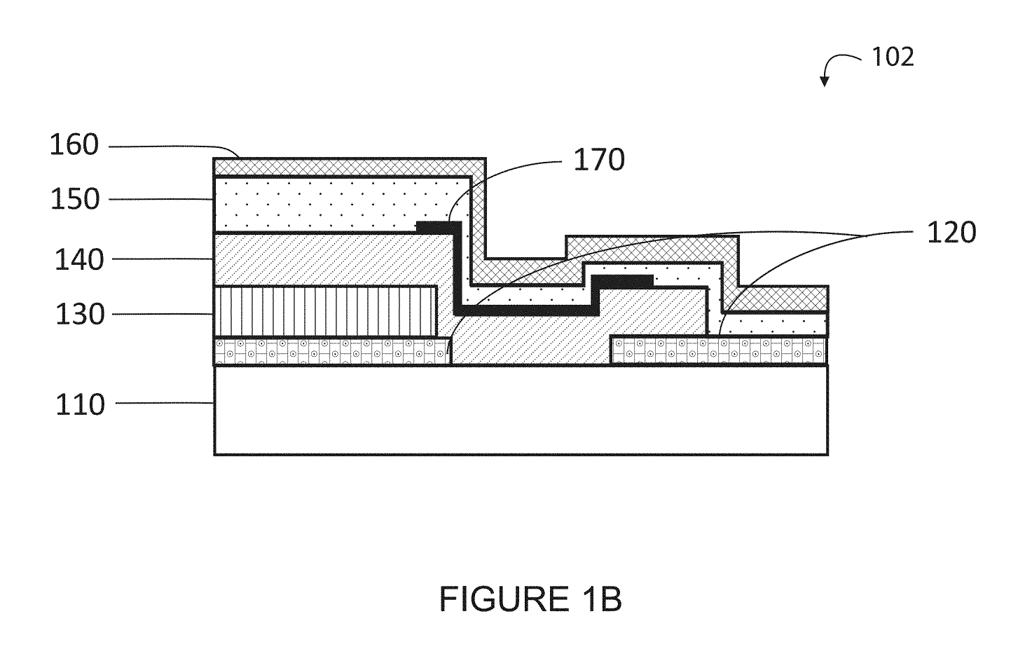

This example demonstrates the effect of a diffusion barrier interlayer within a thin film electrochemical system, which includes a substrate 110, a current collector 120, a cathode 130, an electrolyte 140, an anode 150, and an encapsulation layer 160 (shown in FIGS. 1A and 1B). FIG. 1A is a simplified cross-sectional view of thin film electrochemical energy storage cell according to an embodiment of present invention. FIG. 1A illustrates simplified cross-sectional views of electrochemical cell, 101, near the “bridge” region between cathode active area and anode current collector, where the lithium ion from anode is diffused through and forming the conductive pathway perpendicular to the substrate, across the anode and the anode current collector.

FIG. 1B is a simplified cross-sectional view of a modified thin film electrochemical cell, 102, with an additional diffusion barrier layer over the bridge region between the electrolyte and the anode layers according to an embodiment of present invention. FIG. 1B illustrates a cross-sectional view of a modified electrochemical cell with an additional diffusion barrier layer 170 over the bridge region between the electrolyte and the anode layers to prevent anode species (i.e. lithium ion) from diffusing into the substrate or other under layer materials.

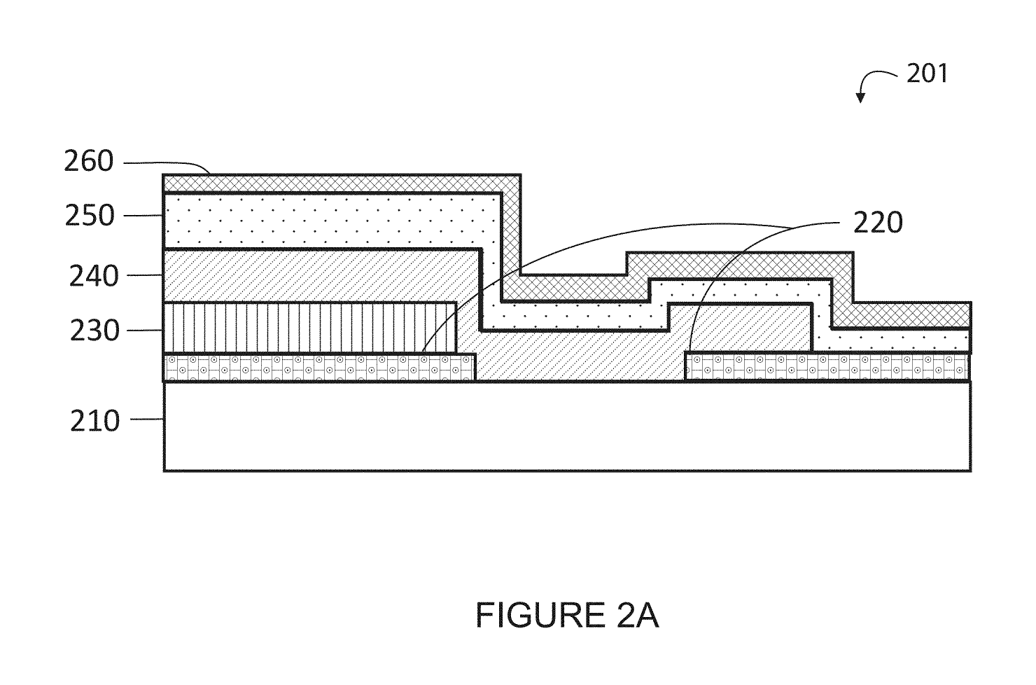

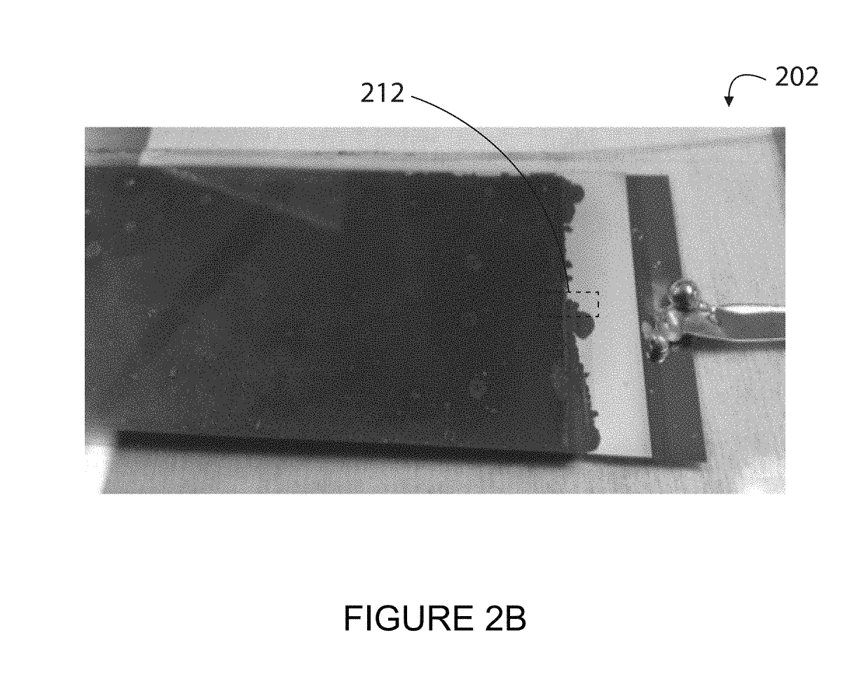

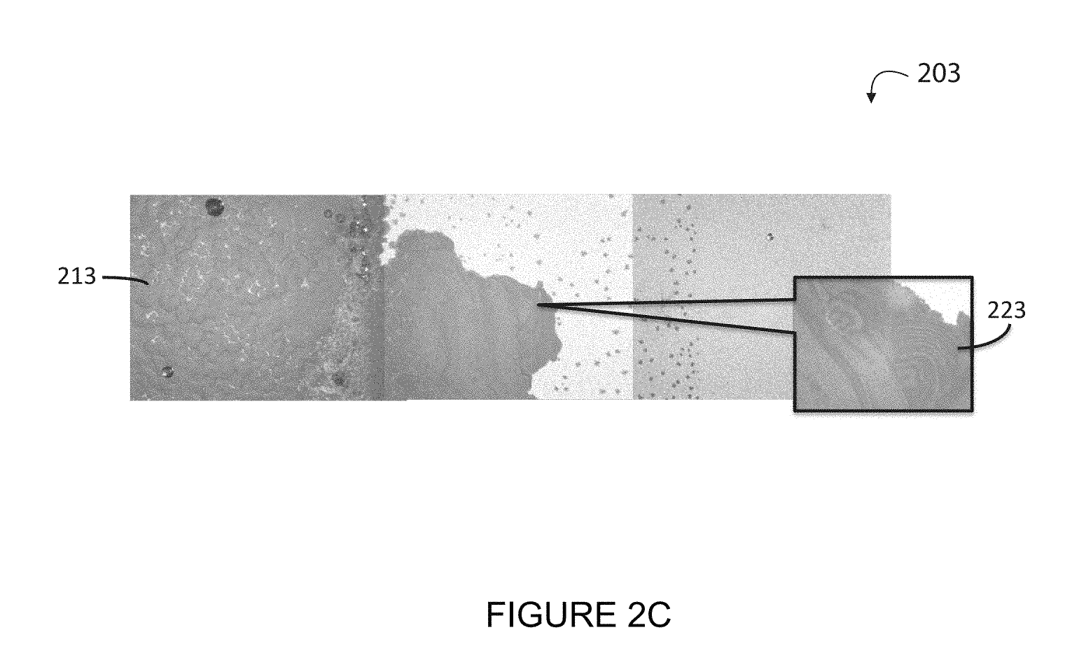

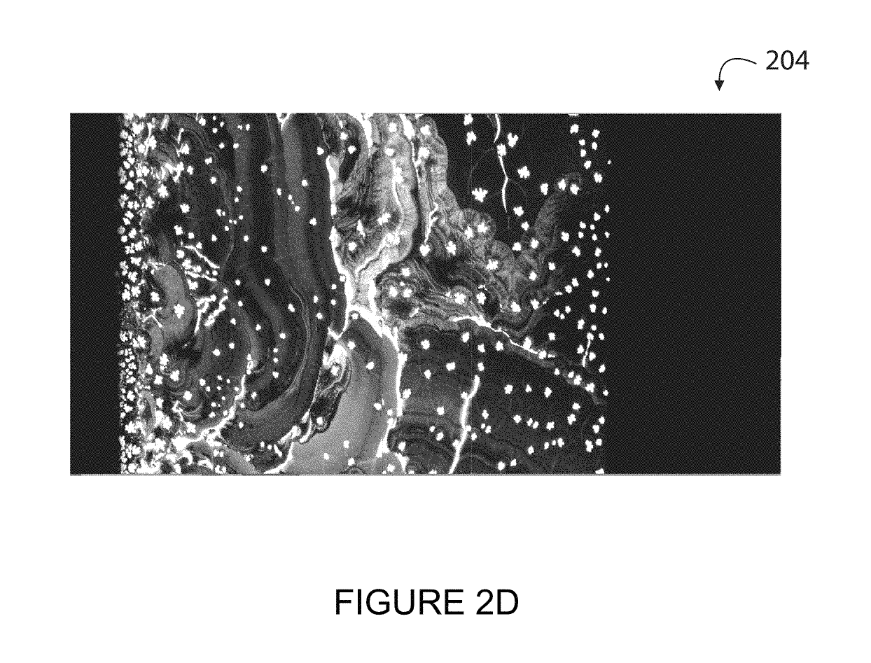

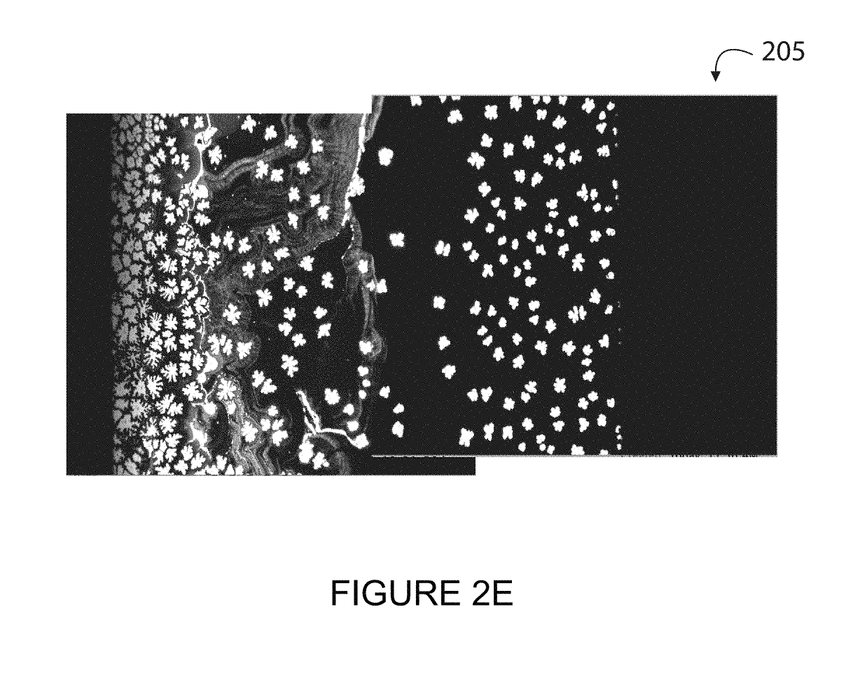

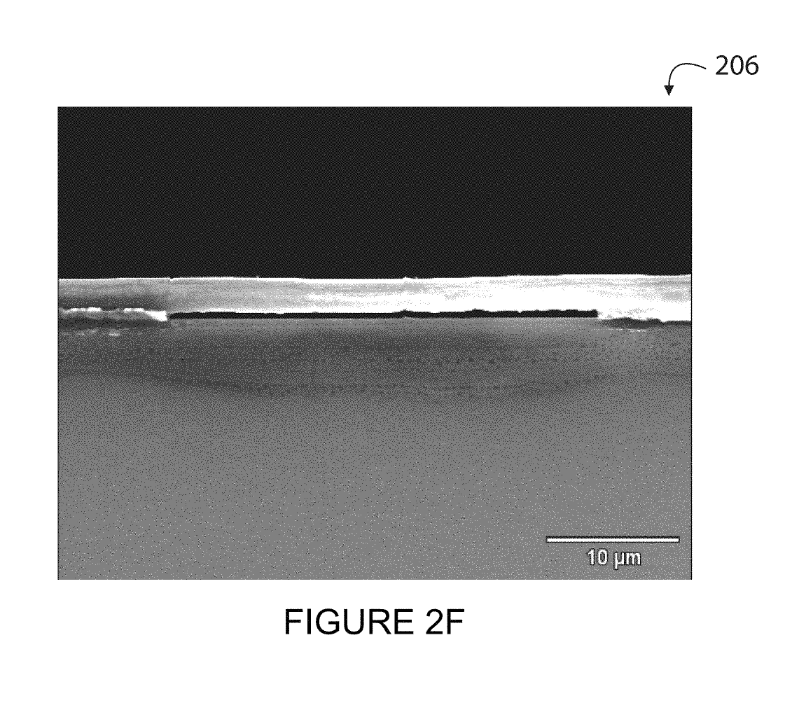

FIG. 2A is a simplified cross-sectional view of a thin film electrochemical energy storage cell according to an embodiment of the present invention. FIG. 2A illustrates an example of the cell construction without an anode barrier layer, showing a schematic cell structure similar to that shown in FIG. 1A. The cell 201 can include a substrate 210, a current collector 220, a cathode 230, an electrolyte 240, an anode 250, and an encapsulation layer 160. Those of ordinary skill in the art will recognize other variations, modifications, and alternatives.

FIG. 2B is a photograph of a thin film electrochemical energy storage cell according to an embodiment of the present invention. The image 202 shows the thin film coupled to an electrical connection. Dotted portion 212 shows a region of focus that for the following figure. This image can be of a cell similar to that shown in FIG. 2A.

FIG. 2C is a microscopic graph view of the same area as the schematic drawing shown in FIG. 2A according to an embodiment of present invention. This image 203 can also be a close up view of the region of focus 212 shown in FIG. 2B. FIG. 2C shows a growth of the lithium corrosion layer 213 in the bridge region wherein corroded lithium is shown as dark layered pattern in the close-up view 223.

FIGS. 2D and 2E are microscopic graph views of the same area as the schematic drawing of FIG. 2A in which a light is shone from the bottom of the specimen according to embodiments of the present invention. FIGS. 2D and 2E show similar microscopic images 204, 205 with a light source placed on the back of the specimen to show the layered patterns and the dots are translucent where lithium anode is missing and corroded to become lithium oxides.

FIG. 2F is a scanning electron microscope graph of the “bridge” region shown in FIG. 2C according to an embodiment of present invention. FIG. 2F shows an SEM image 206 of the cross-section of the bridge region where the anode layer is diffused into the substrate to leave a void between the electrolyte and the encapsulation layer.

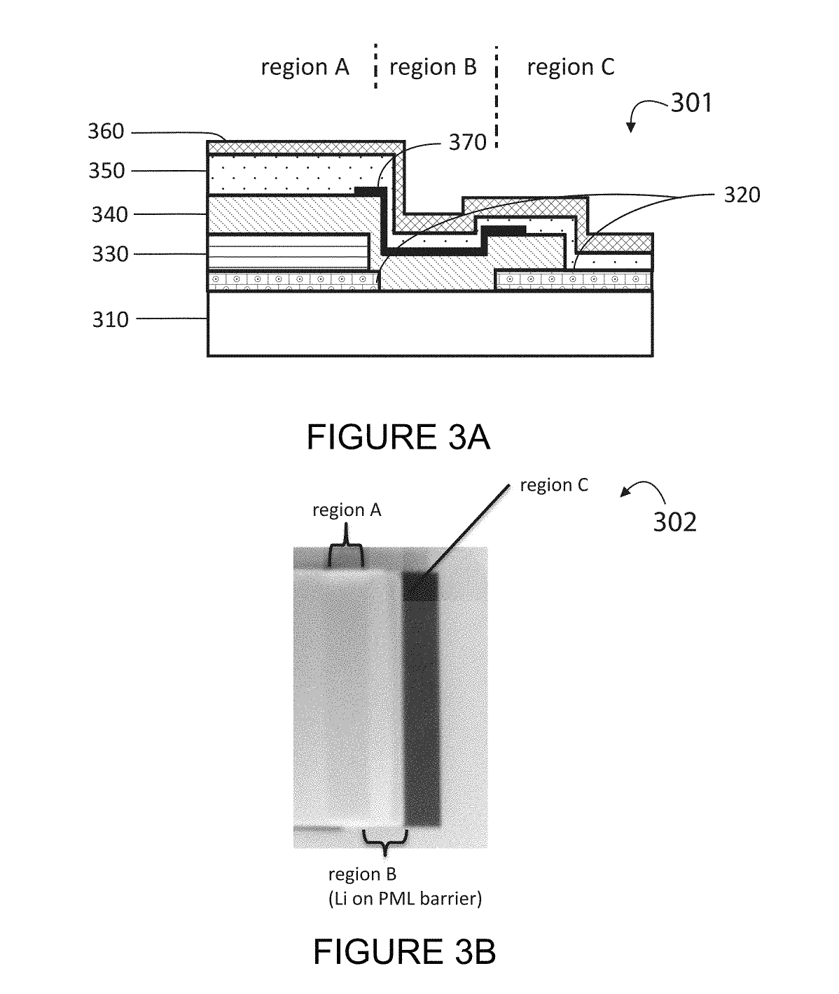

FIG. 3A is a simplified cross-sectional view of the thin film electrochemical energy storage cell having three regions with an additional diffusion barrier layer deposited over a bridge region according to an embodiment of present invention. This cell 301 is similar to the cell shown in FIG. 1B, which includes a substrate 310, a current collector 320, a cathode 330, an electrolyte 340, an anode 350, an encapsulation layer 360, and a barrier layer 370. FIG. 3A is a modified cell structure with an additional diffusion barrier layer deposited over the bridge region (region B) between cell active area (region A) and current collector (region C).

FIG. 3B the picture below shows pristine anode surface across all three regions as shown in FIG. 3A according to an embodiment of the present invention. Image 302 shows the cell with the protection of the barrier layer preventing the reaction between the lithium and the substrate material. Region A corresponds to the cell active area, region B corresponds to the bridge region (Li on PML barrier), and region C corresponds to the current collector of the cell shown previously.

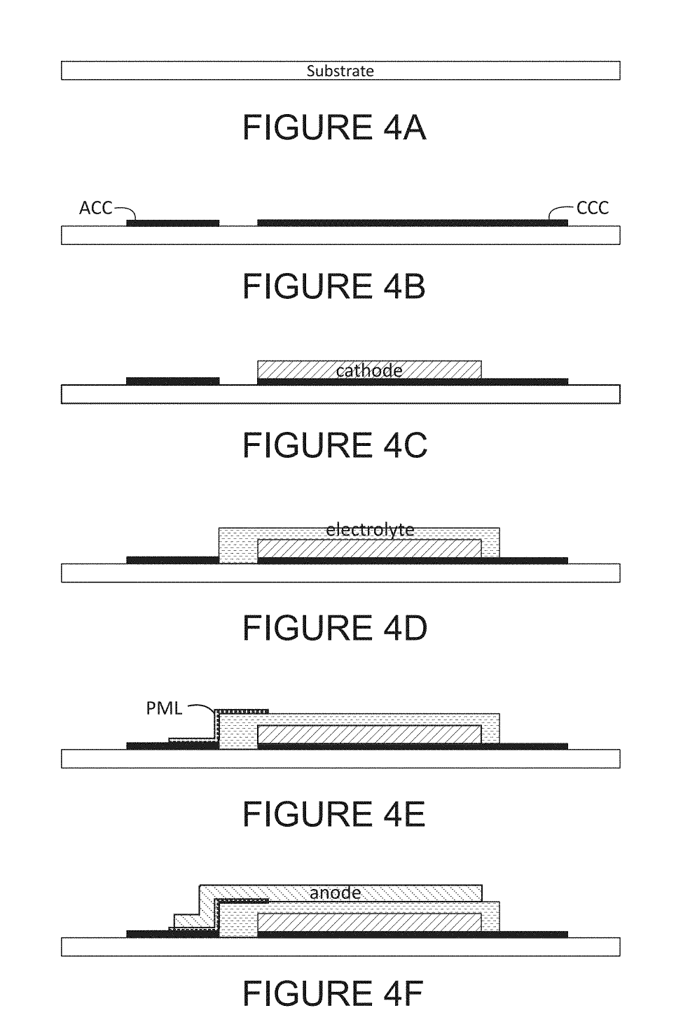

FIGS. 4A-4F illustrate simplified cross-sectional views of each process step showing an electrochemical cell layer formed according to an embodiment of the present invention. A substrate is provided in FIG. 4A. In a first step, the anode and the cathode current collectors (ACC and CCC) are deposited on the substrate (FIG. 4B); in a second step, cathode material is deposited on the cathode current collector (FIG. 4C); in a third step, the material of the electrolyte is deposited over the cathode (FIG. 4D); in a fourth step, the diffusion barrier is deposited over the bridge region across the electrolyte between the active area where the cathode material is deposited and the anode current collector (FIG. 4E); in a fifth step, anode material is deposited over the active area, the bridge region, and a portion of the anode current collector (FIG. 4F).

In some embodiments, the present invention provides a method using multiple thin film layers as diffusing layers. These multiple thin-film layers comprises a disappearing layer, a passage layer, and a diffusing layer (or a host layer), in sequence. The disappearing layer serves as diffusion agent. This disappearing layer is deposited from highly diffusive species including, but not limited to, a group of single elements, such as lithium atoms, lithium ions, protons, sodium ions, and potassium ions, or other ionic species, a group of lithium alloys, including but not limited to lithium magnesium alloy, lithium aluminum alloy, lithium tin alloy, lithium tin aluminum alloy. The passage layer as diffusion medium is comprised of an ionically conductive material and can be selected from, but not limited to, a group of glassy ionic conductive materials such as lithiated oxynitride phosphorus, lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄ (M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X=Cl, Br, I)), with ionic conductivity ranging from 10⁻⁵ to 10⁻¹ S/m; a group of ionic conductive polymers such as poly(ethylene oxide) (PEO).

In some embodiments, the overlaying layer serves as diffusion host once the highly diffusive species diffused from the disappearing layer and react or intercalated into this layer. The candidates for this overlaying layer or diffusion host layer can be selected from, but not limited to, a group of metals such as aluminum, silver copper, zinc, indium, tin; a group of amorphous or crystalline lithiated or non-lithiated transition metal oxide and lithiated transition metal phosphate, wherein the metal is in Groups 3 to 12 in the periodic table, including but not limited to lithium manganese oxide, lithium nickel oxide, lithium cobalt oxide, lithium nickel-cobalt-manganese oxide, lithium nickel-cobalt-aluminum oxide, lithium copper-manganese oxide, lithium iron-manganese oxide, lithium nickel-manganese oxide, lithium cobalt-manganese oxide, lithium nickel-manganese oxide, lithium aluminum-cobalt oxide, lithium iron phosphate, lithium manganese phosphate, lithium nickel phosphate, lithium cobalt phosphate, vanadium oxide, magnesium oxide, sodium oxide, sulfur, metal (Mg, La) doped lithium metal oxides, such as magnesium doped lithium nickel oxide, lanthanum doped lithium manganese oxide, lanthanum doped lithium cobalt oxide.

### EXAMPLE 2

When thin film electrochemical cells are stacked together, a set of electrochemical cells should be connected or isolated to form serial or parallel connections to establish desired voltages or capacities for a specific application. In this example, three lithium batteries are stacked to form three cells in parallel with an electrically isolating interlayer between stacks. Material types such as ceramics or polymers can be used as an isolating interlayer for stacked electrochemical cells with parallel connections. This example compares the effect of planarization of these two material types.

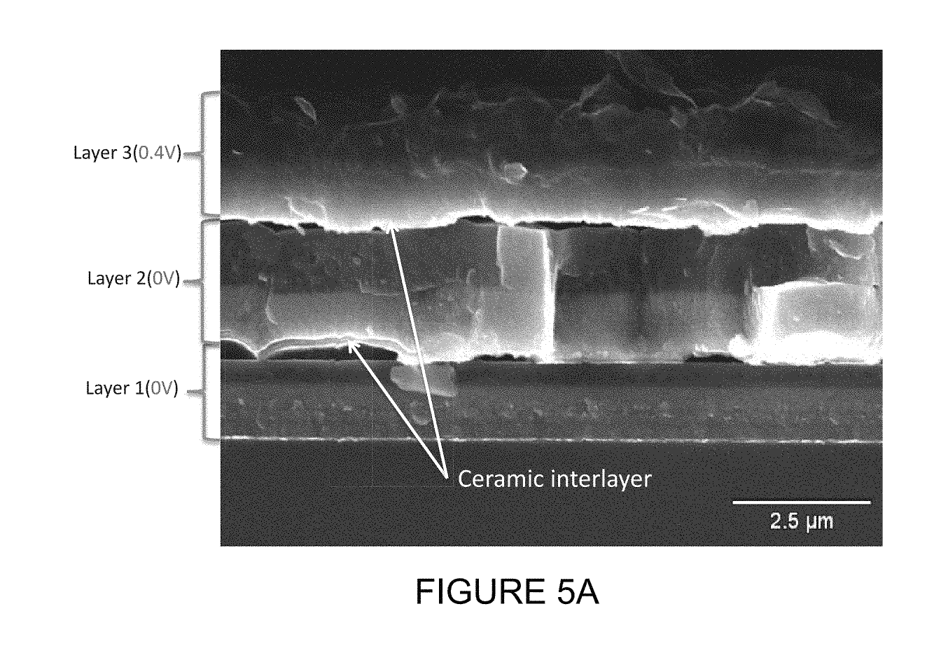

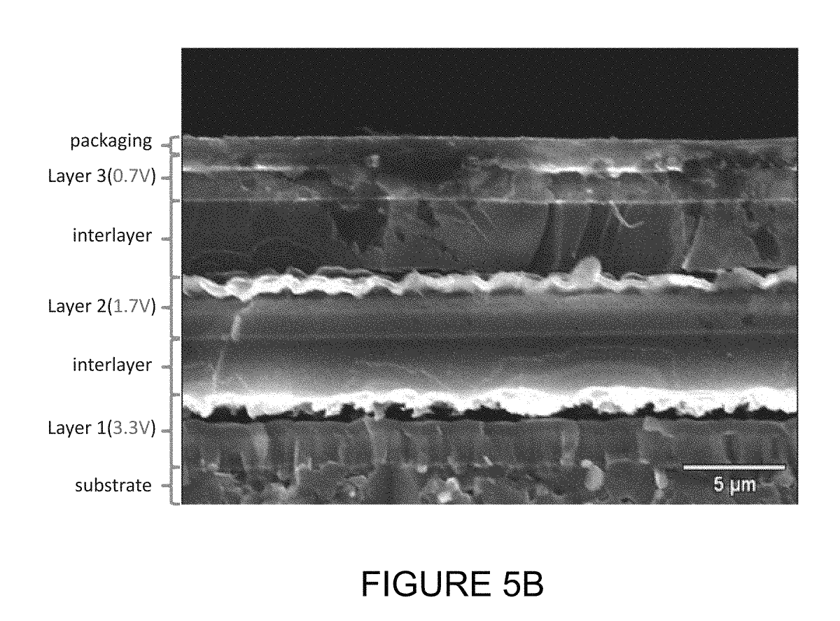

FIG. 5A is a scanning electron microscope graph of three stacks of thin film electrochemical energy storage cells without the interlayers and their cell voltages according to an embodiment of the present invention. In FIG. 5A, the voids under each interlayer is where a lithium layer exists. The wavy contour of the interlayer indicates that the top surface of the lithium was not flat. Due to material properties or process conditions, some materials form an uneven surface when deposited. As seen in the figure, the next layer deposited on top of the interlayer follows the contour. The unevenness propagates and compounds as the number of stacked layers increases (shown in layers 1 through 3), and eventually can form a disconnected layer or work as a stress concentration point.

FIG. 5B is a scanning electron microscope graph of three stacks of thin film electrochemical energy storage cells with the interlayers and their cell voltages according to an embodiment of the present invention. On the other hand, the polymer interlayer shown in FIG. 5B (between each of layers 1 through 3) works as a planarization layer, providing a consistent flat surface for the subsequent layer deposition layer after layer and enabling stacking large number of layers.

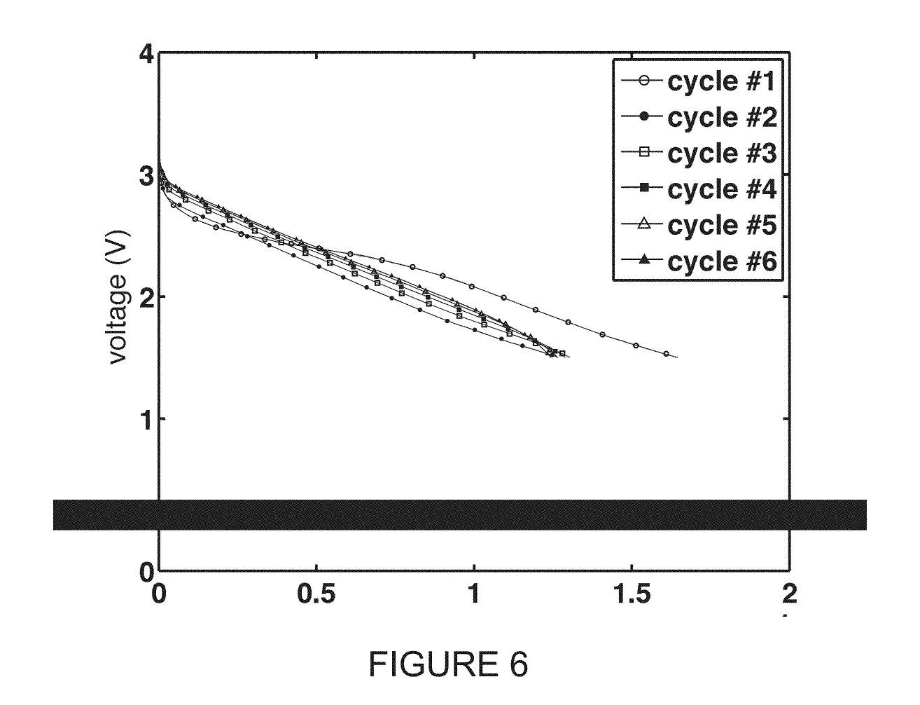

FIG. 6 is a graph representing discharge curves of consecutive 6 cycles of FIG. 5B stacks cells according to an embodiment of the present invention. FIG. 6 demonstrates six consecutive discharge cycles curves of these three stack thin film electrochemical cells with interlayers between each cells. It clearly shows the function ability of the stacked cells. On the contrary, stack cells without interlayers cannot be discharged.

### EXAMPLE 3

As an example encountered by the battery designer, the value of intrinsic stresses distribution for a stacked electrochemical cells setup is unknown. Selection of the proper intermediate layer between layer 1 and layer 2 to reduce the stress is critical to construct a long cycle life battery. This example illustrates the effect of intermediate layer's modulus on stress distribution of stacked electrochemical cells by computer simulation.

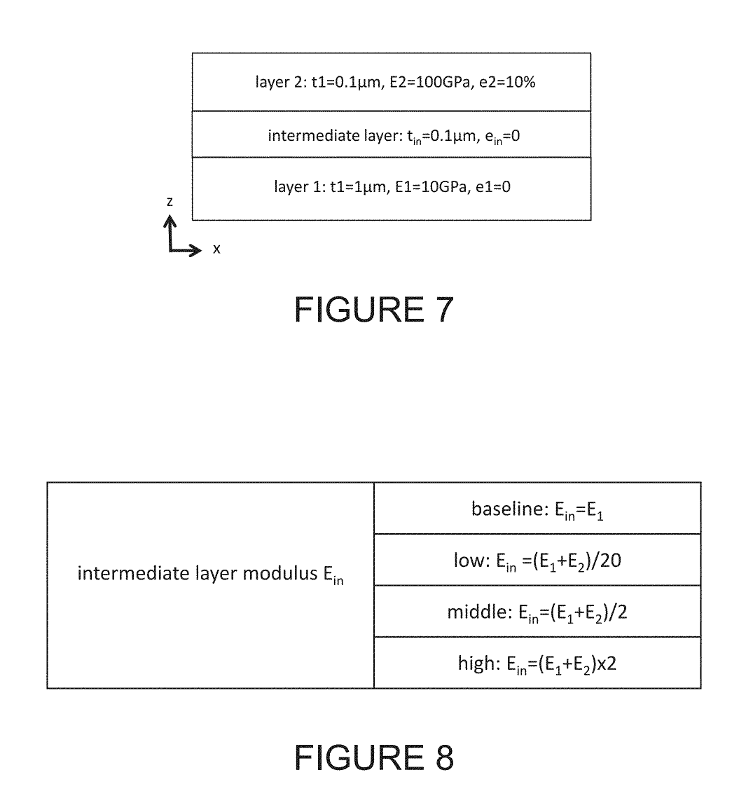

FIG. 7 is a schematic drawing, specs and material properties of two thin film layers sandwiched an intermediate layer according to an embodiment of the present invention. The stacked electrochemical cells setup used in this example is composed of partially completed electrochemical cells, layer 1 and layer 2, as shown in FIG. 7. Modulus contrast ratio of the two layers, E2/E1, is 10. Assuming there is an initial strain of 10% of e2 in layer 2.

FIG. 8 lists four different kinds of moduli of intermediate layer used in the simulation to demonstrate their effect on overall stress distribution inside stacked thin film energy storage cells according to an embodiment of the present invention. The modulus of intermediate layer is selected with four different kinds of moduli as listed in FIG. 8. These four moduli used here are for illustration purposes, but are not limited by these assumptions.

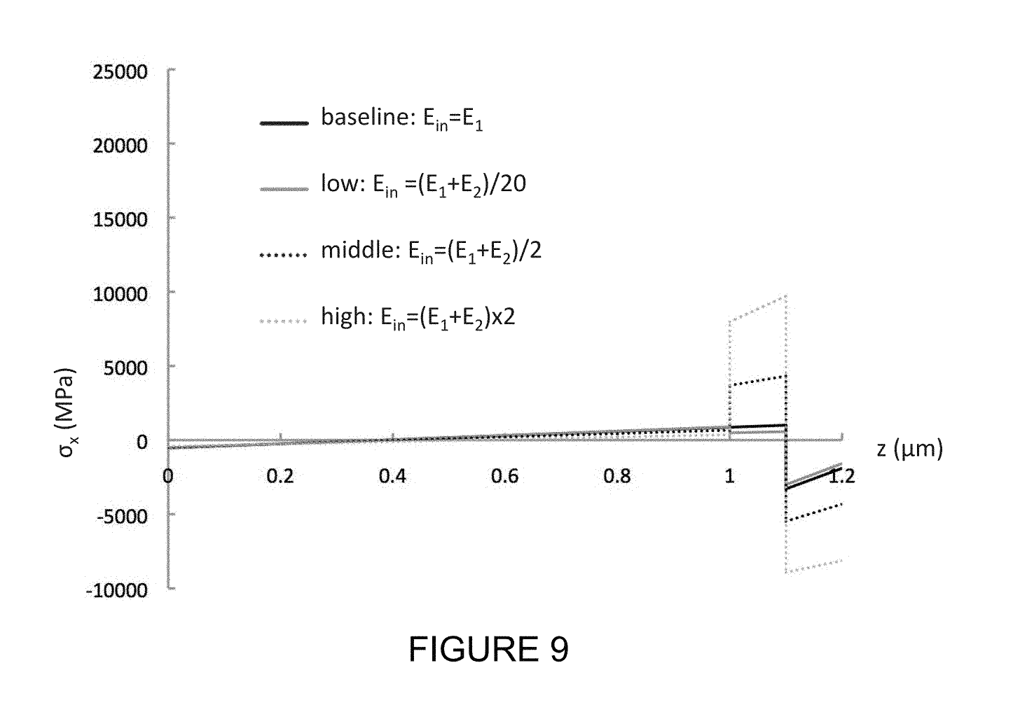

FIG. 9 is stress distribution inside the stacked thin film electrochemical cells obtained by computer simulation according to an embodiment of the present invention. The stress distributions, inside each layers including the intermediate layer, with four different intermediate layers (baseline, low, middle, and high) are shown in FIG. 9. The overall stress distribution can be reduced by selecting low modulus intermediate layer.

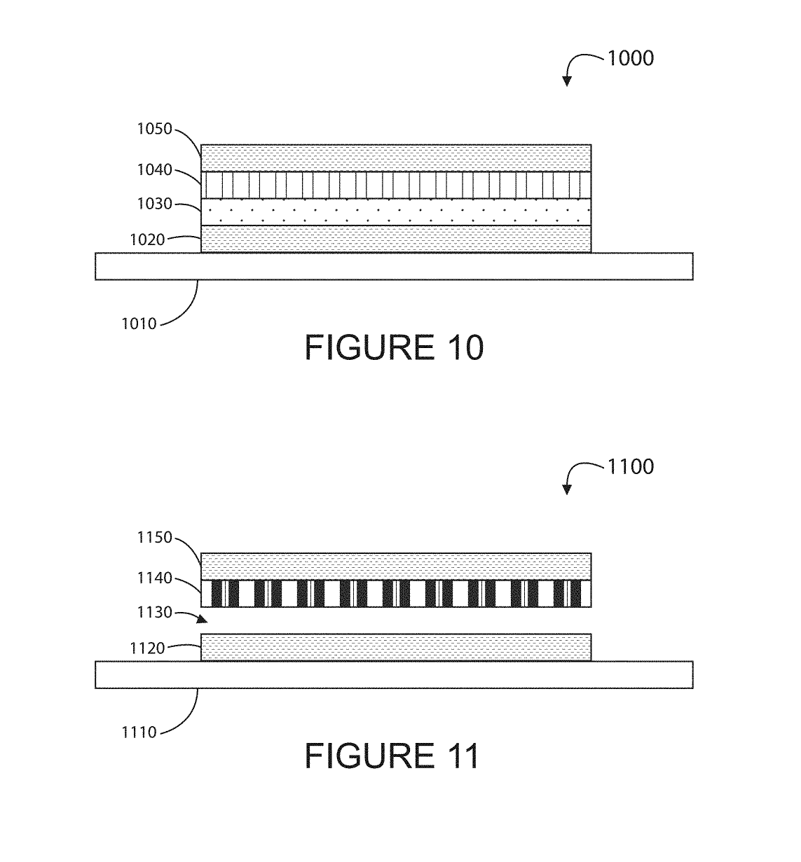

FIG. 10 illustrates an interface region 1000 to be configured between a pair of thin film electrochemical cells according to an embodiment of the present invention. As shown, the illustration is for a multi-layered solid-state battery device. The device has a substrate member, which has a surface region. The device has a barrier material comprising a polymer material overlying the surface region. The device has a thin film battery device layer overlying the barrier material. In an example, the thin film battery device layer comprises a cathode current collector, a cathode device, an electrolyte, an anode device, and an anode current collector. As shown, the illustration shows a pair of polymer regions with a first polymer material 1020 overlying the thin film battery device 1010 and a second polymer material 1050. In an embodiment, these polymer layers can be packaging layers. The illustration has a diffusing region 1030 (e.g., a lithium material) overlying the first polymer material 1020. In an example, the illustration has a trapping material 1040 overlying the lithium material.

FIG. 11 illustrates an interface region 1100, including a void region, between a pair of thin film electrochemical cells according to an embodiment of the present invention. This figure shows a modified version of the interface region shown in FIG. 10. The two packaging layers 1110 and 1150 remain, with the first polymer material 1120 overlying the thin film battery device 1110. In an example, the trapping region 1140 is configured to cause formation a void region 1130 configured between the first polymer material 1120 and a portion of the trapping material 1140 by diffusing a plurality of lithium species from the lithium material to traverse from a spatial region defined by the lithium material after forming the lithium material to the trapping material 1140. This illustration has the second polymer material 1150 overlying the trapping material 1140.

In an example, the aforementioned structure can also be configured with a plurality of N thin film battery devices overlying the second polymer material. Each of the plurality of N thin film battery devices having an associated void region to substantially remove a strain component between each of the plurality of N thin film battery devices with an associated one of the plurality of N thin film battery devices.

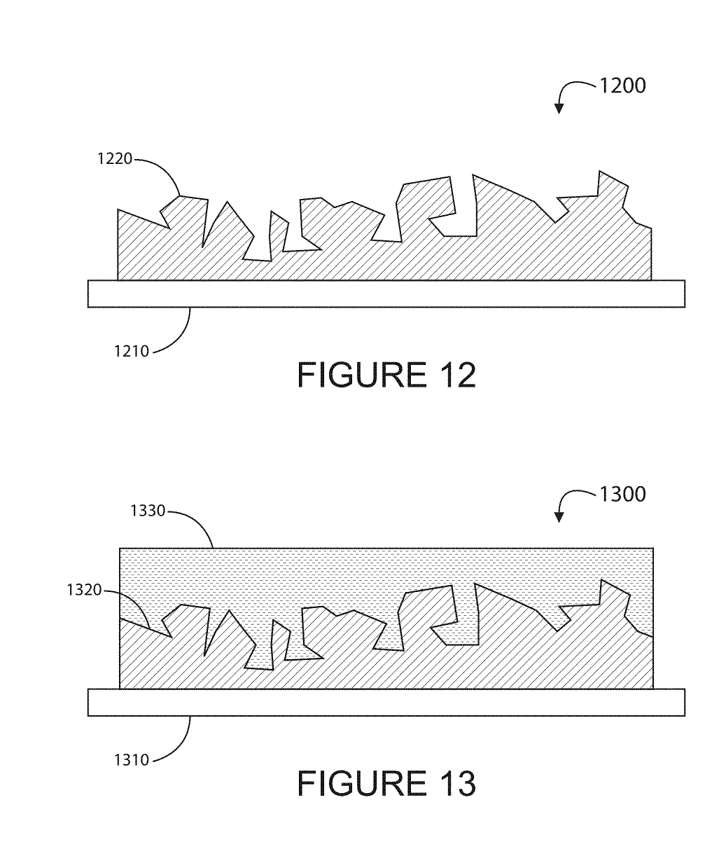

FIG. 12 illustrates a non-uniform cathode material for a thin film electrochemical cell 1200 according to an embodiment of the present invention. As shown is a cathode material 1220 having a non-uniform surface region, which has large gaps, voids, and other imperfections. Layer 1210 represents any layer adjacent to the cathode layer in a thin film electrochemical cell. In other examples, the non-uniform material can be an anode material, or other battery structure.

FIG. 13 illustrates a non-uniform cathode material configured with a polymer material or planarizing fill material for a thin film electrochemical cell 1300 according to an embodiment of the present invention. Here, layer 1310 also represents any layer adjacent to the cathode layer in a thin film electrochemical cell. In an example, the non-uniform cathode material 1320 has an overlying planarizing and/or fill material 1330 to form a planarized surface region. In an example, the planarizing material 1330 can include a first polymer material and the second polymer material that serve as a planarizing structure. In an example, the first polymer material and the second polymer material substantially maintains the thin film battery devices configured with the plurality of N thin film battery devices together and substantially free from delamination while configuring the thin film battery devices together as a single integrated structure and related device.

In an example, the present invention provides an energy storage or all solid-state device performance, improving their cycle lifetime, and enabling operation under high/low temperature and ruggedness condition for such device are provided. The techniques include one or more planarizing layers having inert properties overlay flaws of proceeding layer and prevent failure. Also, means include utilizing intermediate layers or planarizing layers to prevent ionic diffusion and electrical conduction to improve solid-state electrochemical devices and electronic devices. Multiple bi-layered electrolyte layers are used, not only, to enhance the diffusion of active species, but also to mitigate the stress and enable high/low temperature operation of such devices. In an example, a novel disappearing layer method is also used in part of multiple layered diffusion layer so that highly diffusive species can be controlled not to run away to contaminate other functional layers within device.

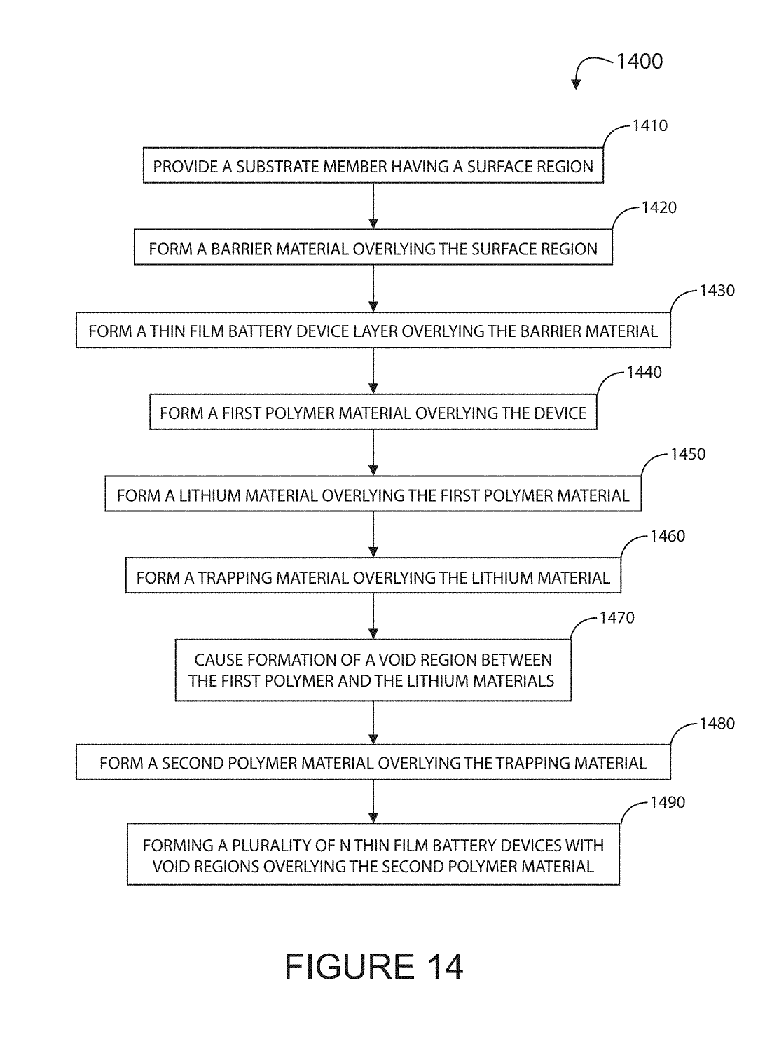

FIG. 14 is a simplified flow diagram illustrating a method of fabricating a multilayered solid-state battery device. As shown, the method 1400 includes: providing a substrate member (step 1410), the substrate member comprising a surface region; forming a barrier material comprising a polymer material overlying the surface region (step 1420); forming a thin film battery device layer overlying the barrier material, the thin film battery device layer comprising a cathode current collector, a cathode device, an electrolyte, an anode device, and an anode current collector (step 1430); forming a first polymer material overlying the thin film battery device (step 1440); forming a lithium material overlying the first polymer material (step 1450); forming a trapping material overlying the lithium material (step 1460); causing formation a void region configured between the first polymer material and a portion of the trapping material by diffusing a plurality of lithium species from the lithium material to traverse from a spatial region defined by the lithium material after forming the lithium material to the trapping material (step 1470); and forming a second polymer material overlying the trapping material (step 1480); and forming a plurality of N thin film battery devices overlying the second polymer material, each of the plurality of N thin film battery devices having an associated void region to substantially remove a strain component between each of the plurality of N thin film battery devices with an associated one of the plurality of N thin film battery devices (step 1490). Other steps can be performed as desired.

These steps are merely examples and should not unduly limit the scope of the claims herein. As shown, the above method provides a security mechanism implementation for integrated devices according to an embodiment of the present invention. One of ordinary skill in the art would recognize many other variations, modifications, and alternatives. For example, various steps outlined above may be added, removed, modified, rearranged, repeated, and/or overlapped, as contemplated within the scope of the invention.

In some embodiments, the substrate member is selected from a glass, a plastic or polymer, a metal, or a ceramic; wherein the first polymer material and the second polymer material serves as a planarizing structure; and increases a contact resistance from a first value to a second value, the second value being greater than the first value; wherein the first polymer material and the second polymer material substantially maintains the thin film battery devices configured with the plurality of N thin film battery devices together and substantially free from delamination while configuring the thin film battery devices together as a single integrated structure and related device.

In some embodiments, the first polymer material, the void region, and the second polymer material are configured to fill in a pin-hole or a crack structure of the thin film batter device; and each of the void regions configured with a pair of polymer material regions are configured to provide any combination of electrical, chemical, and mechanical isolation between any pair of thin film battery devices.

In some embodiments, the first polymer material and the second polymer material are configured to substantially prevent diffusion of oxygen species, a water species, a nitrogen species, and a carbon dioxide species from diffusing into either the thin film battery device or bonding, alloying, or mixing with any of the other layers; the other layers or layer is selected from at least one of a ceramic layer, a soda-lime glass, a borosilicate glass, a NASICON, similar to LiAlCl₄ structure, a β or β″-alumina structure, or a perovskite-type structure, aLiₓPO₄-bLi2S-cSiS₂ where a+b+c equals to 1, LiSON, LiₓLa₁₋ₓZrO₃, LiₓLa₁₋ₓTiO₃, LiAlGePO₄, LiAlTiPO₄, LiSiCON, Li_{1.3}Al_{0.3}Ti_{1.7}(PO₄)₃, 0.5LiTaO₃+0.5SrTiO₃, Li_{0.34}La_{0.51}TiO_{2.94}, LiALCl₄, Li₇SiPO₈, Li₉AlSiO₈, Li₃PO₄, Li₃SP₄, LiPON, Li₇La₃Zr₂O₁₂, Li_{1.5}Al_{0.5}Ge_{1.5}(PO₄)₃, Li₆PS₅Cl, Li₅Na₃Nb₂O₁₂; or a set of polymer: PEO, oligomeric ethylene oxide groups and silicon-based groups distributed in alternating positions between the oligomeric ethylene oxide groups, an aluminum oxide, aluminum nitride, zirconium dioxide (zirconia), magnesium oxide, yttrium oxide, calcium oxide, cerium (III) oxide and boron nitride, or a moisture resistance layer selected from at least one of a metal, a glass, a ceramic, a mica, a silicone a resin, an asbestos, an acrylics, a diallyl phthalate, and a plastic resin.

In some embodiments, the forming of the first polymer material includes evaporating via thermal process; and wherein the first polymer material is configured to fill in gaps or pin holes caused by a process selected from at least one of thermal evaporation, phase-change liquid feeder assisted thermal evaporation, e-beam vapor deposition, radio frequency magnetron sputtering, direct current magnetron sputtering, physical vapor deposition (PVD), chemical vapor deposition (CVD), low pressure chemical vapor deposition (LPCVD), atomic layer deposition (ALD), direct laser writing (DLW), sputtering, microwave plasma enhanced chemical vapor deposition (MPECVD), pulsed laser deposition (PLD), nanoimprint, ion implantation, laser ablation, spray deposition, spray pyrolysis, spray coating, or plasma spraying.

In some embodiments, the first polymer material, the void region, and the second polymer material are configured to reduce a flaw, a stress, or a contact resistance. The first polymer material can be configured with the void region, and the second polymer material causes formation of a planarized surface region. Each of the N thin film battery devices can be formed separately and subsequently bonded via polymer material or each of the N thin film batter devices is formed sequentially from 2 through N. In some embodiments, the first polymer material and the second polymer material, alone or in combination, are characterized by a conductivity lower than 1×10⁻⁷ m²/s.

In some embodiments, the first polymer material and the second polymer material are configured, alone or in combination to substantially prevent a migration of one or more species selected from at least one of Lithium atoms, Lithium ions, protons, sodium ions, and potassium ions, or other ionic species; and wherein the first polymer material and the second polymer material, alone or in combination are characterized by a diffusion coefficient lower than 1×10⁻¹⁷ m²/s.

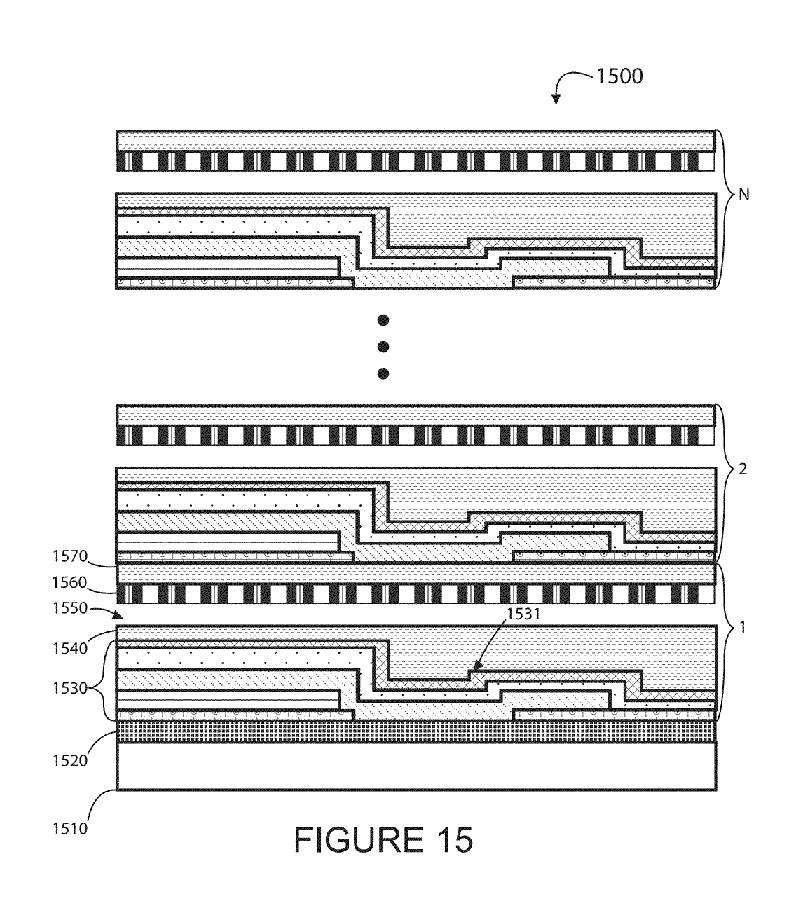

FIG. 15 is a simplified diagram illustrating a multi-layered solid-state battery device according to an embodiment of the present invention. The device 1500 has a substrate member 1510, which has a surface region. The substrate member can be part of a larger device structure, such as a casing, or housing. The device has a barrier material 1520 comprising a polymer material overlying the surface region. The device has a thin film battery device layer 1530 overlying the barrier material. In an example, the thin film battery device layer comprises a cathode current collector, a cathode device, an electrolyte, an anode device, and an anode current collector. The device has a non-planar surface region 1531 configured from the thin film battery device. The device has a first polymer material 1540 overlying the thin film battery device and configured to fill in a gap region of the non-planar surface region and a planarizing surface region configured from the first polymer material. The device has a transferring material overlying the first polymer material and a trapping material 1560 overlying the lithium material. The device has a void region 1550 configured between the first polymer material 1540 and a portion of the trapping material 1560 by diffusing a plurality of transferring species from the transferring material to traverse from a spatial region defined by the transferring material after forming the transferring material to the trapping material and a second polymer material 1570 overlying the trapping material. As used herein and throughout the specification, the terms “first” “second” or “Nth” do not imply any order, and should be interpreted broadly. The device has a plurality of N thin film battery devices overlying the second polymer material. Each of the plurality of N thin film battery devices (enumerated to the right side of the layers: 1, 2 . . . N) has an associated void region to substantially remove a strain component between each of the plurality of N thin film battery devices with an associated one of the plurality of N thin film battery devices.

In some embodiments, each of the first polymer material and the second polymer material is characterized by a thickness less than 500 Angstroms, wherein each of the first polymer material or the second polymer material is selected from one of: a group of elastomers including least one of butyl, styrene butadiene, phenolic, polysulfide, silicone, or neoprene; a group of polymer electrolytes including at least one of lithium salt, AX (where A⁺ is anodic ion and is selected from a group of metals, but not limited to, Li⁺, Na⁺, Mg²⁺, etc., and X⁻ is cathodic ions, but are not limited to, I⁻, Cl⁻, Br⁻, ClO₄⁻, CF₃SO₃⁻, BF₄⁻, and AsF₆⁻), in polymer where polymer is chosen from a group of polymer such as, poly(ethylene oxide) (PEO), poly(propylene oxide) (PPO), poly(ethylene glycol) (PEG), poly(vinylidene fluoride) (PVdF) , poly(acrylonitrile) (PAN), poly(methyl methaacrylate) (PMMA), poly(vinylidene fluoride-hexafluoroproplene) (PVdF-co-HFP); a group of plastic polymers including at least one of cyanoacrylate, polyester, epoxy, phenolic, polymide, polyvinylacetate, polyvinyl acetal, polyamide, acrylic; a group of ceramic or glass including at least one of zirconium oxide, ruthenium oxide, rhodium oxide , iridium oxide, osmium oxide, zirconium boride, titanium nitride, tungsten carbide, tantalum nitride, tungsten nitride, titanium boride, tantalum boride, tungsten boride, lead-alkali borosilicate, or from a group of metal including at least one of zirconium, titanium, rhodium, iridium, osmium, or palladium.

In some embodiments, the device includes a capping layer overlying the N plurality of thin film battery devices. In some embodiments, each of the first polymer material or the second polymer material has a thickness of less than 1 micron. Each of the N plurality of thin film battery devices can be sandwiched between at least a pair of polymer materials. Each of the first polymer material or the second polymer material can be configured with the void region serves as a stress mitigation region.

In some embodiments, the transferring material includes a lithium material that decomposes upon formation of the trapping material. This transferring material is characterized by a thickness upon formation and the void region upon formation of the trapping region. In some embodiments, the transferring material comprises a species that is selected from at least one of a group of single elements including at least lithium atoms, lithium ions, protons, sodium ions, and potassium ions, or other ionic species or a group of lithium alloys, including at least one of lithium magnesium alloy, lithium aluminum alloy, lithium tin alloy, lithium tin aluminum alloy.

In some embodiments, the trapping material is selected from at least one of a group of glassy ionic conductive materials such as lithiated oxynitride phosphorus, lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄(M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m; or a group of ionic conductive polymers including at least one of poly(ethylene oxide) (PEO).

In some embodiments, a compound interlayer region including two or more layers of materials can be configured overlying the planarizing surface of the first polymer material. This compound interlayer region can include materials not involved in electrochemical cell function of the thin film battery, and each layer can have a different composition and functionality. The materials in the compound interlayer region can include a first material characterized by high dielectric strength (e.g. BaO) and a second material chosen from a group of polymers including: poly(ethylene oxide) (PEO), poly(propylene oxide) (PPO), poly(ethylene glycol) (PEG), poly(vinylidene fluoride) (PVdF), poly(acrylonitrile) (PAN), poly(methyl methaacrylate) (PMMA), poly(vinylidene fluoride-hexafluoroproplene) (PVdF-co-HFP); a group of plastic polymers, such as cyanoacrylate, polyester, epoxy, phenolic, polymide, polyvinylacetate, polyvinyl acetal, polyamide, acrylic polymer.

In some embodiments, a compound layer between thin film battery layers comprises a polymer which can be patterned using an electric field applied to one or more layers either while the solid state device is being processed or afterward, to form shapes within the multilayer solid state device which cause voids to be formed between two or more layers.

In some embodiments, the multilayer device is subject to a processing step in which heat is applied in order to change the phase, composition or structure of one or more layers. A polymer deposited as an interlayer becomes a layer of mainly carbon particles following pyrolysis induced by application of heat to a stack of N battery devices or a smaller number of layers within a battery device.

In some embodiments, a multi-layered solid-state battery device comprises: a substrate; a barrier material comprising a polymer material overlying the substrate; a plurality of thin film battery devices overlying the barrier material, each thin film battery device comprising a cathode current collector, a cathode device, an electrolyte, an anode device, an anode current collector, and a non-planar surface region; and at least one interface region overlying one or more of the plurality of thin film batteries, each interface region comprising: a first polymer material layer comprising a planarizing surface region; a void region configured on a surface of the first polymer material layer; a trapping material layer configured on a surface of the void region, wherein the void region comprises voids created by diffusion of a transfer material from the void region to the trapping material layer; and a second polymer material layer configured on a surface of the trapping material layer.

In some embodiments, the first polymer material layer or the second polymer material layer has a thickness less than 100 microns, and wherein the first polymer material layer or the second polymer material layer comprises cyanoacrylate, polyester, epoxy, phenolic, polymide, polyvinylacetate, polyvinyl acetal, polyamide, or acrylic. In some embodiments, the device comprises a capping layer overlying the plurality of thin film battery devices.

In some embodiments, the first polymer material layer or the second polymer material layer has a thickness of less than 100 microns. In some embodiments, each of the plurality of thin film battery devices is sandwiched between at least a pair of polymer materials. In some embodiments, the transferring material comprises a lithium material that diffuses into the trapping material layer upon formation of the trapping material layer. In some embodiments, the transferring material is characterized by a thickness upon formation and the void region upon creation of the void region. In some embodiments, the transferring material comprises a species that is selected from at least one of a group of single elements including at least lithium atoms, lithium ions, protons, sodium ions, and potassium ions, or other ionic species or a group of lithium alloys, including at least one of lithium magnesium alloy, lithium aluminum alloy, lithium tin alloy, lithium tin aluminum alloy. In some embodiments, the trapping material comprises lithiated oxynitride phosphorus, lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, generally described by LiₓM_{1-y}M′_{y}O₄ (M=Si, Ge, and M′=P, Al, Zn, Ga, Sb)), thio-LISICON (lithium super ionic conductor, generally described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m, or poly(ethylene oxide)(PEO).

In some embodiments, a multi-layered solid-state battery device comprises: a substrate; a barrier material comprising a polymer material overlying the substrate; a plurality of thin film battery devices overlying the barrier material, each thin film battery device comprising a cathode current collector, a cathode device, an electrolyte, an anode device, an anode current collector, a non-planar surface region; and at least one interface region overlying one or more of the plurality of thin film batteries, each interface region comprising: a first polymer material layer comprising a planarizing surface region; a void region configured on a surface of the first polymer material layer, the void region comprising voids created by diffusion of a transfer material to a trapping material; a compound interlayer region configured on a surface of the void region, the compound interlayer region comprising two or more layers of materials which are not involved in the electrochemical function of the thin film battery, each having different composition and functionality; and a second polymer material layer configured on a surface of the compound interlayer region.

In some embodiments, the compound interlayer region comprises poly(ethylene oxide) (PEO), poly(propylene oxide) (PPO), poly(ethylene glycol) (PEG), poly(vinylidene fluoride) (PVdF), poly(acrylonitrile) (PAN), poly(methyl methaacrylate) (PMMA), poly(vinylidene fluoride-hexafluoroproplene) (PVdF-co-HFP), cyanoacrylate, polyester, epoxy, phenolic, polymide, polyvinylacetate, polyvinyl acetal, polyamide, or acrylic polymer. In some embodiments, the plurality of thin film battery devices comprises one or more compound layers, the one or more compound layers being patterned during formation of the plurality of thin film battery devices using an electric field applied to form shapes within the multilayer solid state device which cause voids to be formed between two or more layers of the thin film device layer. In some embodiments, the substrate comprises part of a larger device structure, casing, or housing.

It is understood that for the purposes of description of the invention, that the term battery is understood in its broadest sense to include a wide range of energy storage devices wherein charge may or may not be carried by ions, but may instead be transferred directly, for example as in a capacitor, and may traverse some thickness of the device by a variety of physical means including electron/quantum tunneling. It is also understood that the examples and embodiments described herein are for illustrative purposes only and that various modifications or changes in light thereof will be suggested to persons skilled in the art and are to be included within the spirit and purview of this application and scope of the appended claims.

1. A method of fabricating a multi-layered solid-state thin film battery device on a substrate, the method comprising:
forming a first solid-state thin film device layer on a substrate;
forming an interface region overlying the first solid-state thin film device layer;
forming a scaffold material layer overlying the interface region; and
forming a second solid-state thin film device layer overlying the scaffold material layer.

2. The method of claim 1, wherein the substrate is selected from a glass, a plastic or polymer, a metal, or a ceramic, and wherein forming the interface region comprises:
forming an encapsulating polymer material layer comprising a planarizing surface region overlying the first solid-state thin film device layer;
forming a transfer material layer overlying the encapsulating polymer material layer;
forming a trapping material layer overlying the transfer material layer; and
forming a void region located between the encapsulating polymer material layer and at least a portion of the trapping material layer by diffusing a plurality of transferring species from the transfer material layer.

3. The method of claim 2, wherein the encapsulating polymer material layer, the void region, and the scaffold material layer are configured to fill in a pin-hole or a crack structure of the multi-layered solid-state thin film battery device, and the void region provides any combination of electrical, chemical, and mechanical isolation between any pair of solid-state thin film battery device layers of the multi-layered solid-state thin film battery device.

4. The method of claim 2, wherein the encapsulating polymer material layer and the scaffold material layer are configured to prevent diffusion of oxygen species, a water species, a nitrogen species, and a carbon dioxide species from diffusing into either the multi-layered solid-state thin film battery device or to prevent bonding, alloying, or mixing with one or more other layers, wherein the one or more other layers are selected from at least one of a ceramic layer, a soda-lime glass, a borosilicate glass, a NASICON, similar to LiAlCl₄ structure, a β or β″-alumina structure, or a perovskite-type structure, aLiₓPO₄-bLi2S-cSiS₂ where a+b+c equals to 1, LiSON, LiₓLa₁₋ₓZrO₃, LiₓLa₁₋ₓTiO₃, LiAlGePO₄, LiAlTiPO₄, LiSiCON, Li_{1.3}Al_{0.3}Ti_{1.7}(PO₄)₃, 0.5LiTaO₃+0.5SrTiO₃, Li_{0.34}La_{0.51}TiO_{2.94}, LiALCl₄, Li₇SiPO₈, Li₉AlSiO₈, Li₃PO₄, Li₃SP₄, LiPON, Li₇La₃Zr₂O₁₂, Li_{1.5}Al_{0.5}Ge_{1.5}(PO₄)₃, Li₆PS₅Cl, Li₅Na₃Nb₂O₁₂; or a set of polymer: PEO, oligomeric ethylene oxide groups and silicon-based groups distributed in alternating positions between the oligomeric ethylene oxide groups, an aluminum oxide, aluminum nitride, zirconium dioxide (zirconia), magnesium oxide, yttrium oxide, calcium oxide, cerium (III) oxide and boron nitride, or a moisture resistance layer selected from at least one of a metal, a glass, a ceramic, a mica, a silicone, a resin, an asbestos, an acrylics, a diallyl phthalate, and a plastic resin.

5. The method of claim 2, wherein forming an encapsulating polymer material layer comprises evaporating via a thermal process, wherein the encapsulating polymer material layer is configured to fill in gaps or pin holes caused by a process selected from at least one of aerosol deposition, thermal evaporation, phase-change liquid feeder assisted thermal evaporation, e-beam vapor deposition, radio frequency magnetron sputtering, direct current magnetron sputtering, physical vapor deposition (PVD), chemical vapor deposition (CVD), low pressure chemical vapor deposition (LPCVD), atomic layer deposition (ALD), direct laser writing (DLW), sputtering, microwave plasma enhanced chemical vapor deposition (MPECVD), pulsed laser deposition (PLD), nanoimprint, ion implantation, laser ablation, spray deposition, spray pyrolysis, spray coating, or plasma spraying.

6. The method of claim 2, wherein the encapsulating polymer material layer, the void region, and the scaffold material layer are configured to reduce a flaw, a stress, or a contact resistance.

7. The method of claim 2, wherein the scaffold material layer causes the formation of a planarized surface region relative to the void region.

8. The method of claim 2, wherein the encapsulating polymer material layer and the scaffold material layer are configured, alone or in combination, to prevent a migration of one or more of lithium atoms, lithium ions, protons, sodium ions, potassium ions, or other ionic species, and the encapsulating polymer material layer and the scaffold material layer, alone or in combination, are characterized by a diffusion coefficient lower than 1×10⁻¹⁷ m²/s.

9. The method of claim 1, wherein the first solid-state thin film device layer and the second solid-state thin film device layer are batteries each comprising a cathode layer, an electrolyte layer, and an anode layer.

10. A multi-layered thin-film solid-state device comprising:
a substrate;
a plurality of thin film devices overlying substrate, each thin film device comprising a non-planar surface region; and
an interface region overlying one or more thin film devices of the plurality of thin film devices, each interface region comprising:
an encapsulating polymer material layer comprising a planarizing surface region;
a transfer material layer overlying at least a portion of the planarizing surface region of the encapsulating polymer material layer;
at least one void region on a surface of the encapsulating polymer material layer;
a trapping material layer overlying the encapsulating polymer material layer, the at least one void region, and the transfer material layer; and
a scaffold polymer material layer configured on a surface of the trapping material layer; wherein the at least one void region is created by at least partial diffusion of the transfer material layer to the trapping material layer.

11. The device of claim 10, wherein the encapsulating polymer material layer or the scaffold polymer material layer has a thickness less than 100 microns, and wherein the encapsulating polymer material layer or the scaffold polymer material layer comprises cyanoacrylate, polyester, epoxy, phenolic, polymide, polyvinylacetate, polyvinyl acetal, polyamide, or acrylic.

12. The device of claim 10, comprising a capping layer overlying the plurality of thin film devices.

13. The device of claim 10, wherein at least one of the encapsulating polymer material layer and the scaffold polymer material layer has a thickness of less than 10 microns.

14. The device of claim 10, wherein the transfer material layer comprises a lithium material that diffuses into the trapping material layer upon formation of the trapping material layer.

15. The device of claim 10, wherein the transfer material layer comprises at least one species selected from:
a group of single elements including lithium atoms, lithium ions, protons, sodium ions, and potassium ions; or
a group of lithium alloys, including at least one of lithium magnesium alloy, lithium aluminum alloy, lithium tin alloy, lithium tin aluminum alloy.

16. The device of claim 10, wherein the trapping material layer comprises lithiated oxynitride phosphorus, lithium lanthanum zirconium oxide, lithium lanthanum titanium oxide, lithium sodium niobium oxide, lithium aluminum silicon oxide, lithium phosphate, lithium thiophosphate, lithium aluminum germanium phosphate, lithium aluminum titanium phosphate, LISICON (lithium super ionic conductor, described by LiₓM_{1-y}M′_{y}O₄(M=Si, Ge, and M′=P, Al, Zn, Ga, Sb)), thio-LISICON (lithium super ionic conductor, described by LiₓM_{1-y}M′_{y}S₄ (M=Si, Ge, and M′=P, Al, Zn, Ga, Sb)), lithium ion conducting argyrodites (Li₆PS₅X (X═Cl, Br, I)), with ionic conductivity ranging from 10⁻⁵ to 10⁻¹ S/m, or poly(ethylene oxide)(PEO).

17. A multi-layered solid-state device comprising:
a substrate;
a plurality of thin film devices overlying the substrate, each thin film device of the plurality of thin film devices comprising a non-planar surface region; and
at least one interface region between at least two thin film devices of the plurality of thin film devices, each interface region of the at least one interface region comprising:
an encapsulating polymer material layer comprising a planarizing surface region and a void region; and
a compound interlayer region configured on a surface of the encapsulating polymer material layer, the compound interlayer region comprising two or more layers of materials which are not involved in the electrochemical function of the thin film device, each having different composition and functionality.

18. The device of claim 17, wherein the compound interlayer region comprises poly(ethylene oxide) (PEO), poly(propylene oxide) (PPO), poly(ethylene glycol) (PEG), poly(vinylidene fluoride) (PVdF), poly(acrylonitrile) (PAN), poly(methyl methaacrylate) (PMMA), poly(vinylidene fluoride-hexafluoroproplene) (PVdF-co-HFP), cyanoacrylate, polyester, epoxy, phenolic, polymide, polyvinylacetate, polyvinyl acetal, polyamide, or acrylic polymer.

19. The device of claim 17, wherein the plurality of thin film devices comprises one or more compound layers, the one or more compound layers being patterned during formation of the plurality of thin film devices using an electric field applied to form shapes within the multilayer solid state device which causes one or more void regions to be formed between two or more layers of the thin film device layer.

20. The device of claim 17, wherein the substrate comprises part of a larger device structure, casing, or housing.

21. The device of claim 17, wherein the interface region further comprises a scaffold polymer material layer configured on a surface of the compound interlayer region, wherein the one or more void regions comprise voids created by diffusion of a transfer material to a trapping material.
